(19) United States
(12) Patent Application Publication
(10) Pub. No.: US 2009/0164397 A1
(43) Pub. Date: Jun. 25, 2009

(54) Human Level Artificial Intelligence Machine

(76) Inventor: Mitchell Kwok, Honolulu, HI (US)

Correspondence Address: Mitchell Kwok, 1675 Kamamalu Ave, Honolulu, HI, 96813, US

(21) Appl. No.: 12/110,313

(22) Filed: Apr. 26, 2008

Related U.S. Application Data
(63) Continuation-in-part of application No. 12/014,742, filed on Jan. 15, 2008.
(60) Provisional application No. 61/028,885, filed on Feb. 14, 2008.
(60) Provisional application No. 61/015,201, filed on Dec. 20, 2007.

(51) Int. Cl. G06F 15/18; G06K 9/62; A63F 9/00

(52) U.S. Cl. 706/21; 382/160; 463/42; 901/47

(57) ABSTRACT

A method and system for creating exponential human artificial intelligence in robots, as well as enabling a human robot to control a time machine to predict the future accurately and realistically. The invention provides a robot with the ability to accomplish tasks quickly and accurately without using any time. This permits a robot to cure cancer, fight a war, write software, read a book, learn to drive a car, draw a picture or solve a complex math problem in less than one second.

### CROSS REFERENCE TO RELATED APPLICATIONS

This application claims the benefit of U.S. Provisional Application No. 61/028,885 filed on Feb. 14, 2008, this application is also a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to robots and machines thousands of times smarter than human beings.

2. Description of Related Art

How does a machine thousands of times smarter than a human being operate? This patent application isn't written to outline a machine that can think like a human being, but to outline a machine that can think thousands of times smarter than a human being.

A machine that can think thousands of times smarter than a human being is capable of: curing cancer in less than one second, curing old age in less than one second, building a house in less than one second, fighting and winning a war in less than one second, writing a book in less than one second, writing a computer software in less than one second and so forth.

The easy way of making machines or robots that can think thousands of times smarter than a human being is by increasing its processing speed and including a larger disk drive. A faster processor and more disk space means the robot can think 1000's of times faster. However, this method has some drawbacks. For one thing, the machine lives in an environment that has fixed laws. The laws of Physic prevent objects from moving faster than the speed of light. If a robot wants to read a 500 page book in less one second, one second is not enough time to flip through 5 pages of the book. If a machine wants to build a house in less than one second, one second is not enough time to hammer 2 nails. The capacity of super intelligence is there but the environment we live in prevents the machine from carry out its tasks. The only way to solve this problem is to find a way around Einstein's law: nothing goes faster than the speed of light.

### SUMMARY OF THE INVENTION

It is true that nothing can go faster than the speed of light. Certainly no objects in existence were able to do this. But there is one thing that is able to break Einstein's law: a computer. A Playstation 2 game called Prince of Persia allows the character to control time. He can stop time, fast forward in time, slow time or travel back in time. It is this game that gave me the idea that we can actually use a videogame environment to do “work”. “Work” in this case can be: writing a book, drawing a picture, writing software, reading a book, doing research, building a house, planning a war, building new technology, or practicing a sport.

Time in a videogame is void because 20 years in a videogame can pass and only 1 second has passed in the real world. The time in the videogame depends on the computer processor and disk space. This means that we can stay in a videogame environment for 20 years working on a computer software or doing research without worry about time.

The present invention comprises: a human robot has a built in virtual world (which serves as a 6^{th} sense). Inside the virtual world is a time machine which is a computer that contains a realistic videogame environment of the real world. The robot is able to copy himself into the time machine to do “work”. The videogame environment in the time machine should have the same laws as the real world such as gravity, atom structures, chemical reactions from atom interactions and so forth. This videogame environment in the time machine is equivalent to the “computer generated dream world” in the matrix movie or the “holodeck” in Star Trek.

If the robot wants to spend time in the time machine he can activate his 6^{th} sense and his mind will be transported into the virtual world. He will then have to set the videogame environment in the time machine. The videogame environment will greatly depend on what the robot wants to accomplish. If the robot wants to write a book, the videogame environment can be a simple room with a desk, a chair, paper, pencil, reference books and a computer. If the robot wants to do his math assignment, the videogame environment can be a math room with a copy of the math book, pencil, paper, a computer, a chair and a desk. In other cases the videogame environment has to be a copy of an area in the real world such as a crime scene, wherein all atom structures are identical and physic laws are emulated.

The robot can also save all his work (data files) on a computer in the real world. After completing his work in the videogame environment the robot will transport himself out of the time machine and into the virtual world. Then he will transport himself out of the virtual world and back into the real world. The reason that a virtual world is needed to contain the time machine will be given in detail in this patent application. When the robot is in the real world he can use the knowledge he learned in the time machine to do tasks quickly. Data files done in the time machine is copied in the robot's home computer. So, if the robot has spent 20 years in the time machine writing an operating system he can access the software on his home computer.

The present invention can also be used in a variety of applications such as building intelligent search engines to search for data. “The storage part of the human artificial intelligence program can also be used to organize all content over the internet”. Movies, songs, html files, software programs, pictures, and other computer files are organized using commonality groups and learned groups. The intelligence of the machine can be used to search for information over the internet.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating a program for human artificial intelligence according to an embodiment of the present invention.

FIGS. 2A-D are diagrams depicting how the AI program predict future pathways by analyzing universal pathways in memory.

FIGS. 3-5 are diagrams depicting methods to fabricate future pathways through hierarchical analysis of pathways in memory.

FIG. 6 is a diagram depicting intersection points of dominant future pathways.

FIGS. 7-12 are diagrams demonstrating how the AI program predicts future pathways based on infinite possibilities.

FIG. 13 is a diagram illustrating how commonality groups organize data in memory.

FIG. 14 is a diagram illustrating the data structure of a commonality group and the data structure of an average object.

FIG. 15 is a flow diagram depicting how data in memory can shrink into manageable search areas.

FIGS. 16-19C are diagrams illustrating how commonality groups organize data in memory.

FIGS. 20-22 are diagrams depicting how pathways self-organize in memory.

FIGS. 23A-29 are diagrams further depicting how pathways self-organize in memory.

FIGS. 30A-34B are diagrams depicting a network that self-organizes data using both commonality groups and learned groups.

FIG. 35 is a diagram depicting a human robot with a built in time machine in accordance to an embodiment of the present invention.

FIG. 36 is a diagram illustrating the steps virtual characters in the time machine can follow to modify outputs from an AI program.

FIG. 37 is diagram illustrating a hierarchical structure of conscious thoughts to represent a movie.

FIG. 38 is a diagram depicting how a virtual character modifies the output of a future pathway by using various functions from the AI program.

FIGS. 39A-39F are diagrams demonstrating how visual images are compared.

FIG. 40 is a diagram depicting how past pathways are fabricated.

FIG. 41 is a diagram illustrating the data structure of a universal brain.

FIG. 42 is a diagram illustrating how virtual characters in the time machine can predict the past with pinpoint accuracy.

### DESCRIPTION OF THE PREFERRED EMBODIMENTS

The present invention provides a method for robots to have exponential intelligence by interfacing it with a time machine. Certain parts of the human artificial intelligence program will also be outlined in this patent application including: future prediction regarding infinite possibilities and self-organization of data in memory.

Outline:

1. Overall AI program

2. Future prediction

3. Self-organization

4. Robots that can think thousands of times smarter than a human being

5. Other topics

Future prediction and self-organization have been explained in parent applications, this application serve as supplementary information. Detail or additional information is also provided about future prediction and self-organization in the human artificial intelligence program.

Future prediction isn't easy when dealing with life because the possible outcomes of life are infinite. If robots want to predict the future for simple games like chess or checkers its easy using the current AI methods. However, more complex situations with infinite possible outcomes will prove difficult. There are some future predictions that are so difficult that it would require information at the moment in order to predict. An addition problem for example, if a math teacher wants the robot to do an addition problem, then the robot has to predict what the equation will be. Predicting what the equation will look like is impossible because all the numbers in the equation can be anything. The robot will only be able to predict the future steps of the addition problem only after identifying the equation. It is the purpose of the present invention to predict the future for pathways with infinite possible outcomes. In the case of the math problem, the robot will predict the addition problem before the equation is given. Instead of predicting what the addition problem will be, the robot will predict a strategy sequence to handle infinite addition problems. It is also the purpose of the present invention to give detailed information about commonality groups and learned groups to organize data in the human artificial intelligence program.

Overall AI Program

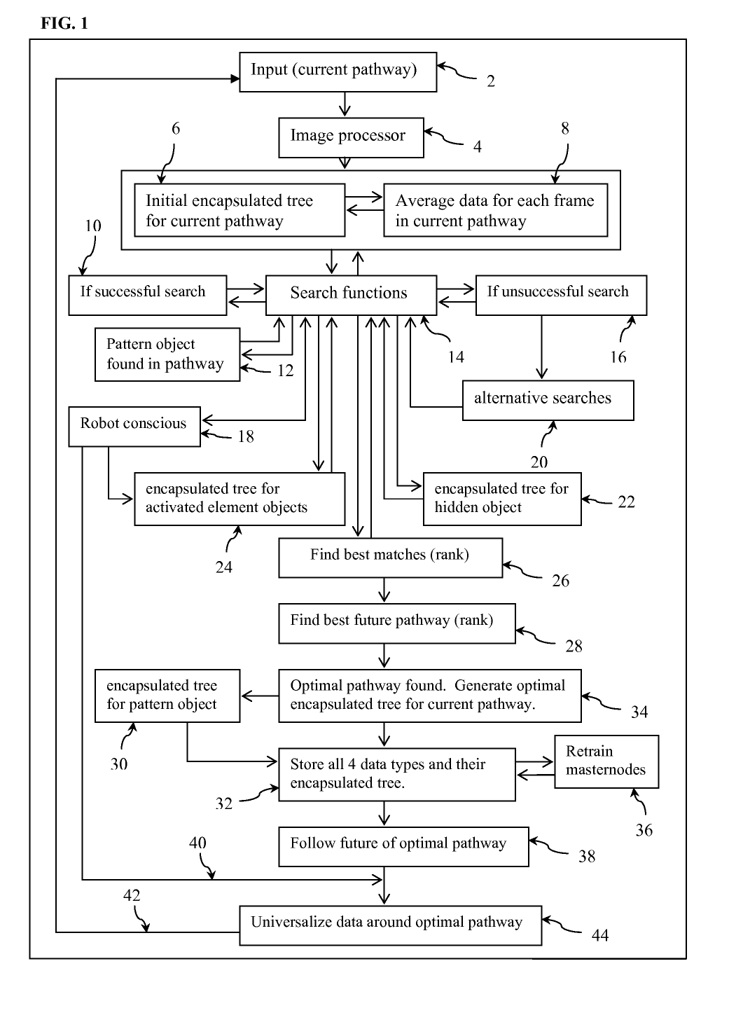

Referring to FIG. 1, the present invention is a method of creating human artificial intelligence in machines and computer based software applications, the method comprising:

an artificial intelligent computer program repeats itself in a single for-loop to receive information, calculate an optimal pathway from memory, and taking action; a storage area to store all data received by said artificial intelligent program; and a long-term memory used by said artificial intelligent program.

Said an AI program repeats itself in a single for-loop to receive information from the environment, calculating an optimal pathway from memory, and taking action. The steps in the for-loop comprises:

1. Receive input from the environment based on the 5 senses called the current pathway (block 2).

2. Use the image processor to dissect the current pathway into sections called partial data (also known as normalized visual objects). For visual objects, dissect data using 6 dissection functions: dissect image layers using previous optimal encapsulated trees, dissect image layers that are moving, dissect image layers that are partially moving, dissect image layers by calculating the 3-dimensional shape of all image layers in the movie sequence, dissect image layers using recursive color regions, and dissect image layers based on associated rules (block 4).

3. Generate an initial encapsulated tree for the current pathway and prepare visual object variations to be searched (block 6).

Average all data in initial encapsulated tree for the current pathway and determine the existence state of visual objects from sequential frames (block 8).

4. Execute two search functions to look for best pathway matches (block 14).

The first search function uses search points to match a visual object to a memory object. Uses breadth-first search because it searches for visual objects from the top-down and searches for all child visual objects before moving on to the next level.

The second search function uses guess points to match a memory object to a visual object. It uses depth-first search to find matches. From a visual object match in memory the search function will travel on the strongest-closest memory encapsulated connections to find possible memory objects. These memory objects will be used to match with possible visual objects in the initial encapsulated tree. This search function works backwards from the first search function.

The first search function will output general search areas for the second search function to search in. If the second search function deviates too far from the general search areas, the second search function will stop, backtrack and wait for more general search areas from the first search function.

The main purpose of the search function is to search for normalized visual objects separately and slowly converge on the current pathway (the current pathway is the root node in the initial encapsulated tree). All visual objects in the initial encapsulated tree must be matched. Search points and guess points call each other recursively so that top-levels of normalized visual objects will eventually be searched as well as bottom-levels of normalized visual objects.

5. Generate encapsulated trees for each new object created during runtime and include it in the initial encapsulated tree.

If visual object/s create a hidden object then generate encapsulated tree for said hidden object. Allocate search points in memory closest to the visual objects that created the hidden object (block 22).

If visual object/s activates element objects (or learned object) then generate encapsulated tree for said activated element objects. Search in memory closest to the visual object/s that activated the element object (block 24).

If pathways in memory contain patterns determine the desirability of pathway (block 12).

6. If matches are successful or within a success threshold, modify initial encapsulated tree by increasing the powerpoints and priority percent of visual object/s involved in successful search (block 10).

If matches are not found or difficult to find, try a new alternative visual object search and modify initial encapsulated tree by decreasing the powerpoints and priority percent of visual object/s involved in unsuccessful search. If alternative visual object search is a better match than the original visual object match modify initial encapsulated tree by deleting the original visual object/s and replacing it with said alternative visual object (block 16 and 20).

7. Objects recognized by the AI program are called target objects and element objects are objects in memory that have strong association to the target object. The AI program will collect all element objects from all target objects and determine which element objects to activate. All element objects will compete with one another to be activated and the strongest element object/s will be activated. These activated element objects will be in the form of words, sentences, images, or instructions to guide the AI program to do one of the following: provide meaning to language, solve problems, plan tasks, solve interruption of tasks, predict the future, think, or analyze a situation. The activated element object/s is also known as the robot's conscious (block 18 and pointer 40).

8. Rank all best pathway matches in memory and determine their best future pathways. A decreasing factorial is multiplied to each frame closest to the current state (block 26 and block 28).

9. Based on best pathway matches and best future pathways calculate an optimal pathway and generate an optimal encapsulated tree for the current pathway. All 5 sense objects, hidden objects, and activated element objects (learned objects) will construct new encapsulated trees based on the strongest permutation and combination groupings leading to the optimal pathway (block 34).

If the optimal pathway contains a pattern object, copy said pattern object to the current pathway and generate said pattern object's encapsulated tree and include it in the optimal encapsulated tree (block 30).

10. Store the current pathway and the optimal encapsulated tree (which contains 4 data types) in the optimal pathway (block 32).

Rank all objects and all of their encapsulated trees from the current pathway based on priority and locate their respective masternode to change and modify multiple copies of each object in memory (block 36).

11. Follow the future pathway of the optimal pathway (block 38).

12. Universalize data and find patterns in and around the optimal pathway. Bring data closer to one another and form object floaters. Find and compare similar pathways for any patterns. Group similar pathways together if patterns are found (block 44).

13. Repeat for-loop from the beginning (pointer 42)

The basic idea behind the AI program is to predict the future based on pathways in memory. The AI program will receive input from the environment based on 5 sense data called the current pathway. The image processor will break up the current pathway into pieces called partial data. The image processor also generates an initial encapsulated tree for the current pathway. Each partial data will be searched individually and all search points will communicate with each other on search results. Each search point will find better and better matches and converge on the current pathway until an exact pathway match is found or the entire network is searched. During the search process, visual objects will activate element objects (learned objects) or create hidden objects. Each new object created by the visual object/s will generate their respective encapsulated tree and included in the initial encapsulated tree. The optimal pathway is based on two criteria: the best pathway match and the best future pathway. After the search function is over and the AI program found the optimal pathway, the AI program will generate an optimal encapsulated tree for the current pathway. All 5 sense objects, all hidden objects, all activated element objects (or learned objects) and all pattern objects will recreate (or modify) encapsulated trees based on the strongest encapsulated permutation and combination groupings leading up to the optimal pathway. Next, the current pathway and its' optimal encapsulated tree will be stored near the optimal pathway. Then, the AI program follows the future instructions of the optimal pathway. Next, it will self-organize all data in and around the optimal pathway, compare similar pathways for any patterns and universal data around that area. Finally, the AI program repeats the function from the beginning.

Predicting the Future Using Hierarchical Data Analysis

The AI program uses entire universal pathways from memory to come with the most likely future pathways. Two factors will be used to analyze universal pathways: pathway intersections and pathway strengths. After many training, universal pathways are structured in a hierarchical manner and each state in a pathway has a probability of when the next state will occur. The job of the AI program is to determine which future pathway will most likely occur in a hierarchical manner, wherein future pathways are ranked based on the most accurate future prediction and most detailed future prediction.

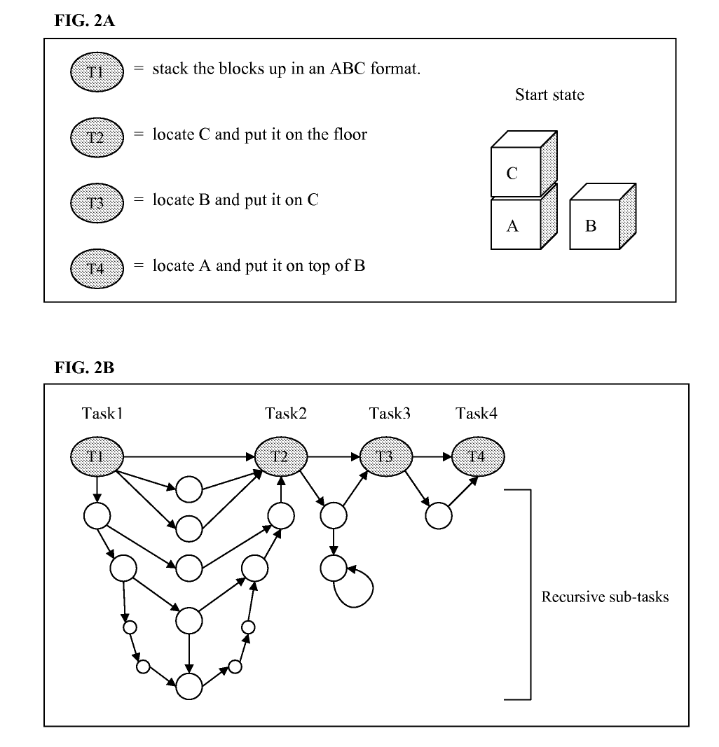

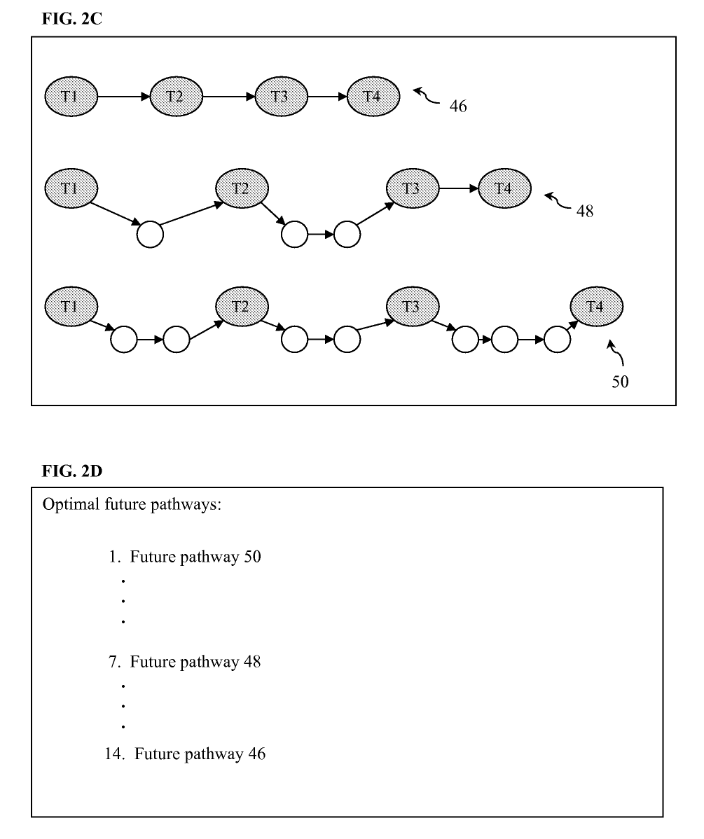

FIG. 2A-B shows a universal pathway to solve the ABC block problem. This universal pathway is structured in such a manner that the most important tasks are outlined first (T1-T4). Within each task are encapsulated sub-tasks and they are also arranged in a hierarchical manner. Referring to FIG. 2C, the AI program will first predict tasks that are consistent and don't have much variations. Pathway 46 is a simple future pathway that is most likely to occur. If there are variations to a future pathway then the AI program has to generate future pathways for each dominant possibility. In Pathway 48 the future pathway is more detailed and instructions in most of the tasks are inserted in pathway 48 based on the most likely event to happen. Pathway 50 is an even more detailed future pathway. This will go on and on until every frame and every data in the frame is predicted for each future pathway. Predicting future pathways will depend primarily on the strongest future possibilities and not all future possibilities.

Pathways in memory have 4 different data types: 5 sense objects, hidden objects, activated element objects and pattern objects. The job of the AI program is to try to predict all 4 different data types in future pathways. All frames and all details in each frame in a given future pathway are to be predicted. This would be a very very very difficult task because the AI program not only has to predict what the machine will sense from the environment, but also predict what the activated element objects will be and predict what the hidden objects will be (hidden data generated from the 5 senses) and predict what the pattern objects will be in future pathways. For example, if the AI program predicts that it will witness an event; and this event triggers a logical thought, the AI program has to predict what this logical thought is. Despite this difficult problem, the future prediction doesn't have to be 100 percent accurate, it can be approximate. As long as there exist some kind of pattern between similar future pathways, an approximate future prediction is efficient.

Referring to FIG. 2D, each future pathway will be ranked based on which future pathway is most likely to happen. Usually the rankings will have detailed future pathways at the top level and summarized future pathways on the bottom level. As new frames are encountered from the environment the rankings shift and some future predictions are discarded while new future pathways are generated. With the addition of new frames the detailed future pathways will change dramatically while the summarized future pathways stay the same. Future pathway 46 doesn't change while a large part of future pathway 50 changes dramatically.

Predicting the Future for Infinite Possibilities

Sometimes predicting the future is impossible because a certain state in a future pathway require data that can be anything. Imagine you are trying to predict a math problem without knowing what the equation is. The variations can be infinite and even if the AI program predicts the future of a math problem based on the most likely equations, the outcome of the prediction will not be optimal. In order to solve this problem words and sentences are used to represent future possibilities that are infinite. If the AI program wants to predict the future of solving a math problem, but doesn't know what the equation is then it will use sentences stating when it will start solving a math problem and it will also use sentences stating when it has finished solving the math problem. The details of the math problem will be delayed until more data comes in. In the moment when the AI program receives the equation of the math problem it will predict the future in detail what steps it has to take to solve the problem. This will go on and on until every frame of the math problem is predicted. The logic behind the math problem will also have to be predicted.

Language will encapsulate entire possibilities, events, descriptions, tasks, objects and so forth. Sentences will also encapsulate the time it takes for certain tasks to be accomplished. Referring to FIG. 5, task1 is: put the B block on the floor. The sub-tasks is to: look around and find the B block, instruct right arm to reach for the B block, grab the B block and hold on to it, instruct the right arm to move to an empty space close-by, instruct arm to move down until the block touches the floor, finally let go of the block slowly. These steps are either lessons thought and guided by teachers or they are patterns founded by the robot autonomously. These steps, in terms of sentences or events, encapsulate practically all possible ways of accomplishing the task: “put the B block on the floor”. It doesn't matter where the B block is located in the environment, it doesn't matter what the B block look like in the environment—these steps are designed for infinite possibilities. However, in order to get a more accurate future prediction, the robot has to predict each future pathway with more details, such as: what the block will look like, where should the block be located, what does the block look like at each frame when it reaches for the B block and so forth. Like I said, the robot will have a more accurate detail of the future as more data is encountered.

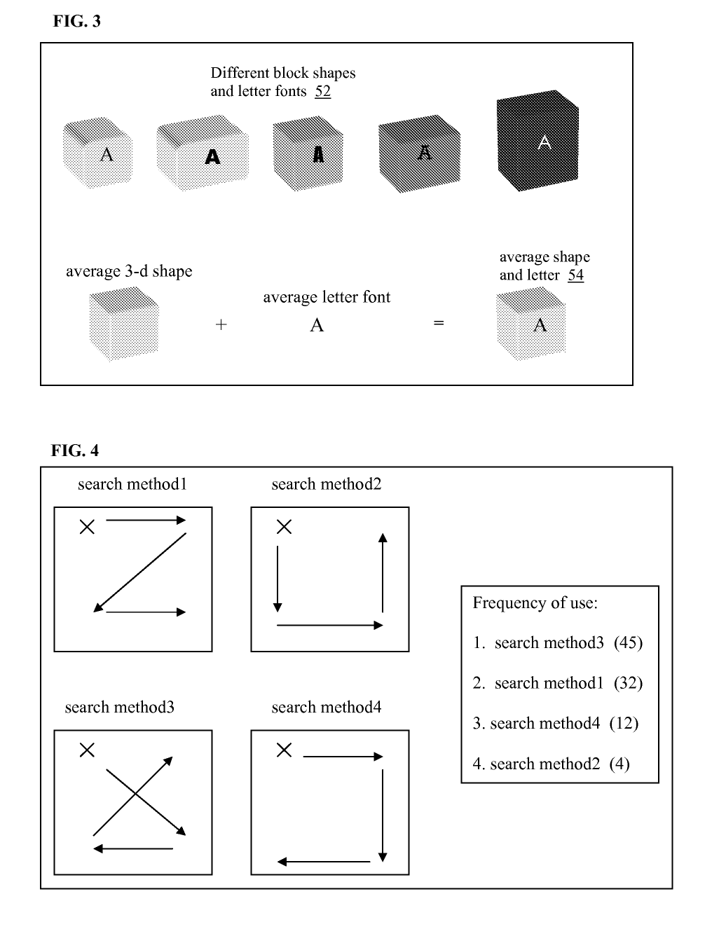

Using fuzzy logic and learned words to represent infinite variations of a problem. After solving the ABC problem over and over again, the AI program should have an average pathway of all the different ways the problem can be solved. The blocks used to solve the problem should also be averaged out, wherein the blocks can be any color or size or shape and the robot will still be able to solve the problem. FIG. 3 shows the different types of blocks 52 that are used and block 54 is the average shape and color of blocks 52. In the case of block objects there exist an encapsulated object. The letter of the block is one object and the block itself is another object (average block 54).

When trying to predict frame-by-frame objects, the AI program will predict the average shape and letter of the block first (based on past data). Then it will attempt to predict what the actual image of the block and the actual image of the letter will look like. It will also attempt to predict the exact location of the block in each frame in the future pathway.

Another way of representing fuzzy logic in terms of objects is by using words to represent the same objects. A mouse and a dog look different, but they are both animals. The word animal groups the mouse and dog as the same object. A popular computer game called Bejeweled uses jewels as objects in the game. These jewels can be in the shape of a diamond, pentagon, sphere or cube. Despite there physical differences each object is known as a jewel. The AI program can use words to represent an object. If the AI program sees that there are no similarities between many examples, but they are all classified by a word, then the word will be used to represent that object. This technique is used in the prediction function to fabricate future pathways.

Another technique to predict future pathways that are infinite is by searching and identifying objects in the environment. The robot can be looking at certain blocks arranged in an arbitrary manner. It is difficult to follow a certain search method to look for a block. Should the robot look to the right or should the robot look to the left first? If you think about the various ways that it can search for an object it can be infinite. This is why searching and identifying objects should not be determined by each frame in memory, but by analyzing the most frequent way to search for and identify an object. Referring to FIG. 4, X marks the spot the robot is focusing on and the arrows are the direction it will move its eyes to search for an object. Given that location X is the same spot for all examples, by analyzing similar pathways the AI program can use a probable search method based on frequency of use. Notice that search method3 is used most frequently. This will be the search method to look for objects. Search method 1-4 are possibilities and each are considered possible future pathways.

Referring to FIG. 5, after adding in these methods of predicting the future for the task: “put the B block on the floor”, the future pathway is more detailed and predicting the future for infinite possibilities has now been narrowed down tremendously. The first step is: put the B block on the floor. Steps 2-7 are sub-tasks. Block 56 is the sub-task of step 2. Referring to pointer 58, upon identifying the B block, the AI program will predict what the average block will look like, then as more data comes in a more detail description of what the block will look like and finally, have a specific description of what the block will look like including the color of the block, the shape of the block, the specific font and color of the letter.

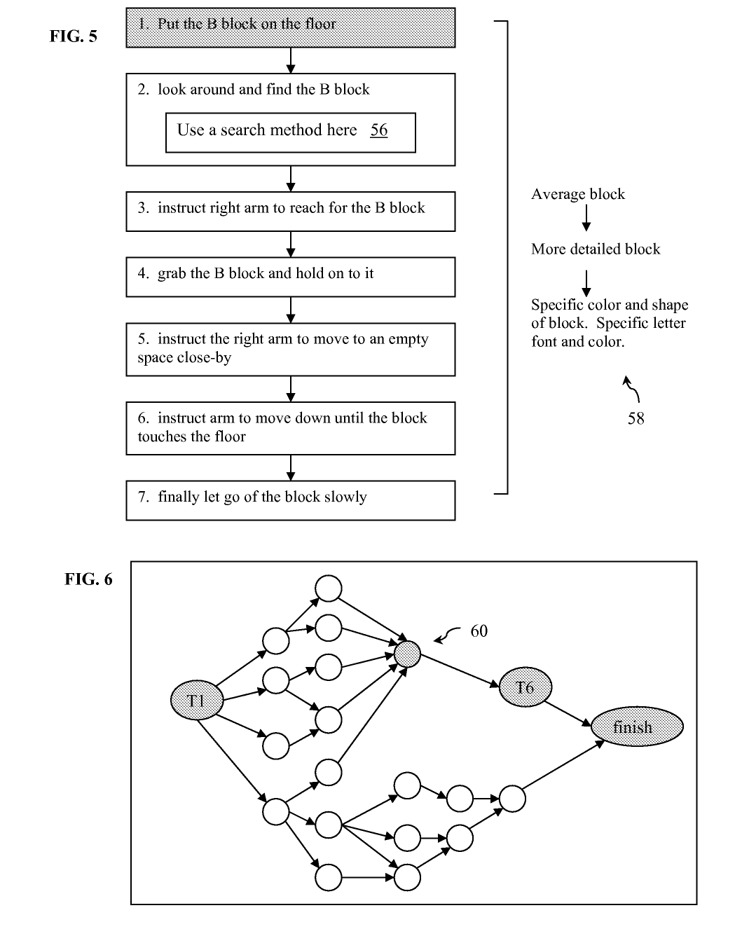

By analyzing and observing pathways in the universal pathway to solve the ABC block problem the robot can find pathways that force all pathways to converge on a limited amount of possibilities. Imagine that the robot has to predict the future on the ABC block problem, but the robot doesn't know how the blocks are stacked and where the blocks are located. It has to find the intersection points of dominant future pathways and use that to solve the ABC block problem without knowing where the blocks are or how the blocks are stacked. For example, in FIG. 6, the robot found a pathway that is most frequently used by the robot that can cater to all ABC block problems without knowing where the blocks are and how the blocks are stacked. The sentences: “put all blocks on the floor” (task 60) and “stack the blocks with C then B and finally A” (T6), summarizes everything perfectly. Instead of predicting which two blocks are stacked on each other or where to put the second block, the AI program can simply put all the blocks on the floor and from that state predict how it will stack up the blocks so that the blocks are arranged in an ABC order. This technique requires the AI program to find the optimal pathway of a universal pathway that can solve a task in the smallest amount of possibilities. This technique also gives the AI the ability to control the future of what happens by looking at strong intersection points such as task 60.

Solving the Problem on Preconditions and Post Conditions in a STRIP Program

In a recursive strip program there are preconditions, post conditions, add list and delete list. In the HAI program these four functions are not used. For example, opening a door require a precondition of a key in order to open a door. Without the key the door can't be opened. If using the strip program the preconditions must be met before moving on to the next step. In the HAI program having the key is a learned thing. Sometimes the robot forgets the key, and as a result, the door can't be opened. Remembering to do things is a learned thing. Teachers must teach the robot to remember to have certain items in order to fulfill certain tasks. In the case the robot forget certain items, teachers have thought the robot to remember to have certain items in future situations. There is a second factor to remembering things and that is though pain and pleasure. If the robot forget to pick up a house key, when it has to open the door to his house the robot might go through extreme pain just to get the house keys. Because of the pain, the robot will remember to get the house keys in future situations.

When the robot forgets the house keys it will use logical thoughts to get the house keys. It might try something like breaking into the house through a window or there might be a spare key in the back of the house or go to a friend's house to get the house keys. The robot will take the most optimal pathway. This is similar to how the recursive strip program will execute a plan recursively to get the house keys if the house key is not in the precondition.

Predicting the Future Based on Universal Future Pathways and Patterns

In terms of predicting the future based on infinite possibilities an extension of the last example would be to include not only sentences and events, but also universal future pathways and patterns. When playing a game like Tetris or Bejeweled the possibilities are endless and the pathways do not reflect an adequate strategy to play these games. In order to solve this problem the AI program has to create universal future pathways in terms of strategies and patterns. This method is equivalent of putting expert AI programs to play specific games in future pathways.

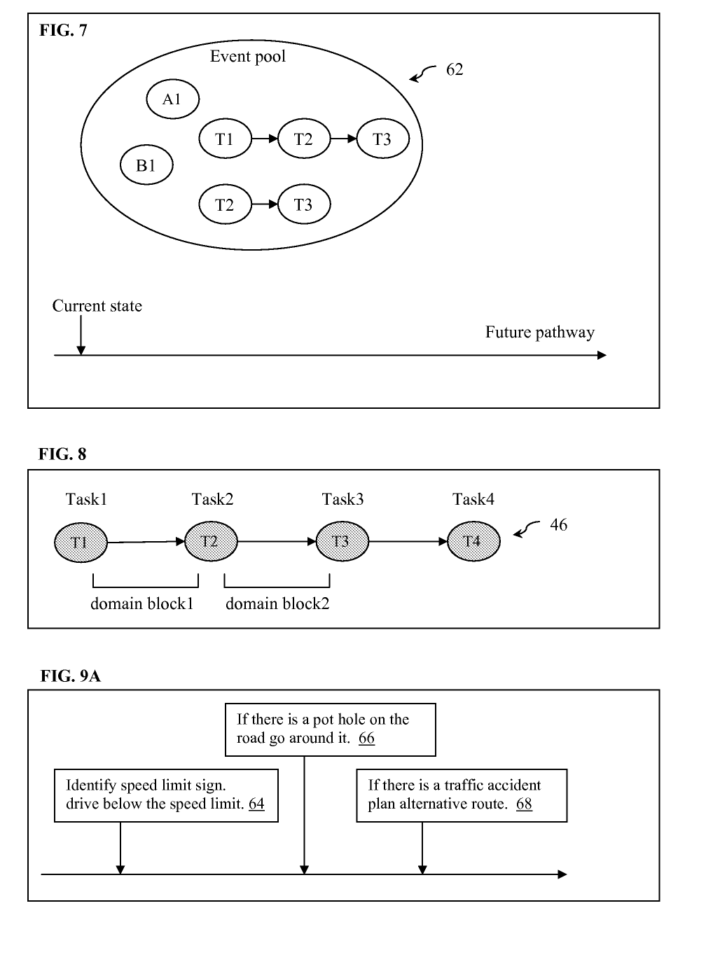

Referring to FIG. 7, a universal future pathway comprises: an event pool and a future pathway (including a timeline). The event pool contains tasks and task sequences and each task or task sequence has a pointer to when it will happen in the future pathway. Tasks can be anything, it can be a sentence or an event. The time that a task will occur in the future pathway can have several values: exact time, estimated time, constant time or void time. If a task or task sequence has an exact time that means the robot knows exactly when that task will occur (very rare). If a task or task sequence has an estimated time that means the robot will have a time range when that task will occur. If a task or task sequence has a constant time that means the task is continuous and the robot is executing the task continuously. Driving a car for example require the driver to continuously drive in the middle of two lines on the road. Finally, if a task or task sequence has a void time that means the robot doesn't know when that task will happen and it might or might not happen within a given domain block.

Each task has a domain block in the future pathway that states the task will happen within a certain domain. In FIG. 8, the start of task1 and the beginning of task2 is one domain block and the beginning of task2 and the beginning of task3 is another domain block. These domain blocks are usually defined by a sentence or an event. There is no start state of a task or an end state only sentences or events stored in pathways that represent the start and end of a task.

Referring to FIG. 8, task1, task2, task3 and task4 are individual tasks and pathway 46 is a task sequence. Task sequences can grow exponentially as more tasks are added to the sequence. This is why only the most frequently occurring task sequences are used for future predictions.

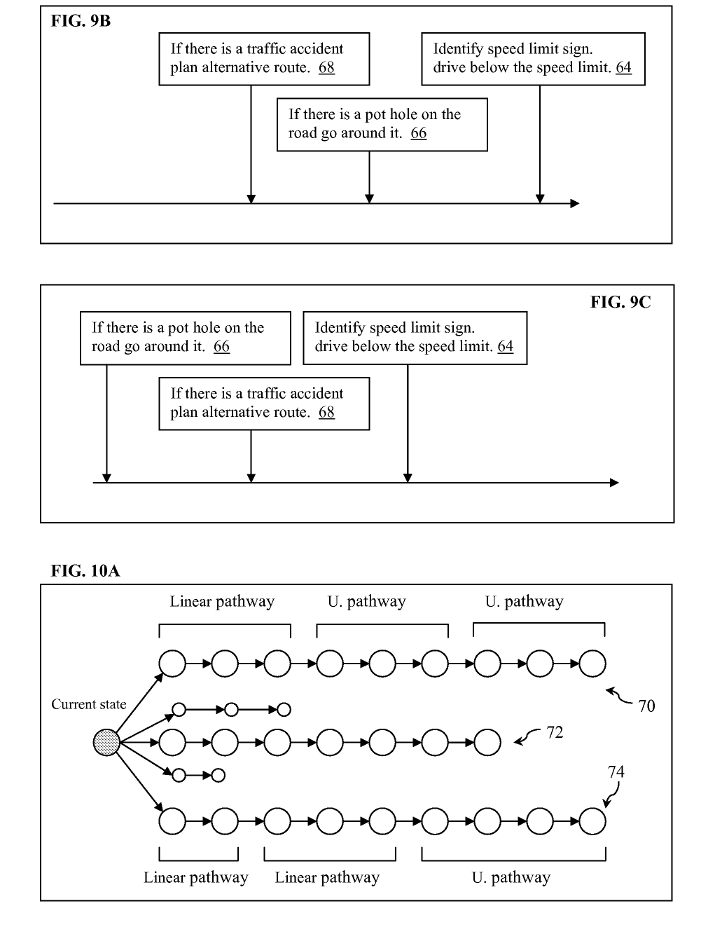

Referring to FIG. 7, the event pool contains all tasks and task sequences that will most likely occur in the future pathway. Encapsulated tasks in task sequences can also be included in the event pool (pointer 62). Sometimes there are tasks that will occur, but there is no exact time that it will occur. In FIG. 9A-C are three pathways with the same tasks (task 64, task 66 and task 68), but they occur at different times. Because all three tasks occur at unpredictable times, all three tasks are put into the event pool. These tasks may or may not happen in the future pathway, but there is a high probability that they might happen; and the timing of tasks will be random or within an estimated time period.

Notice that in the event pool tasks can be represented as “anything”, most notably by sentences or an event. Tasks can be if-then statements, when-statements, for-loops, or any discrete math function that is represented by a sentence or pattern event.

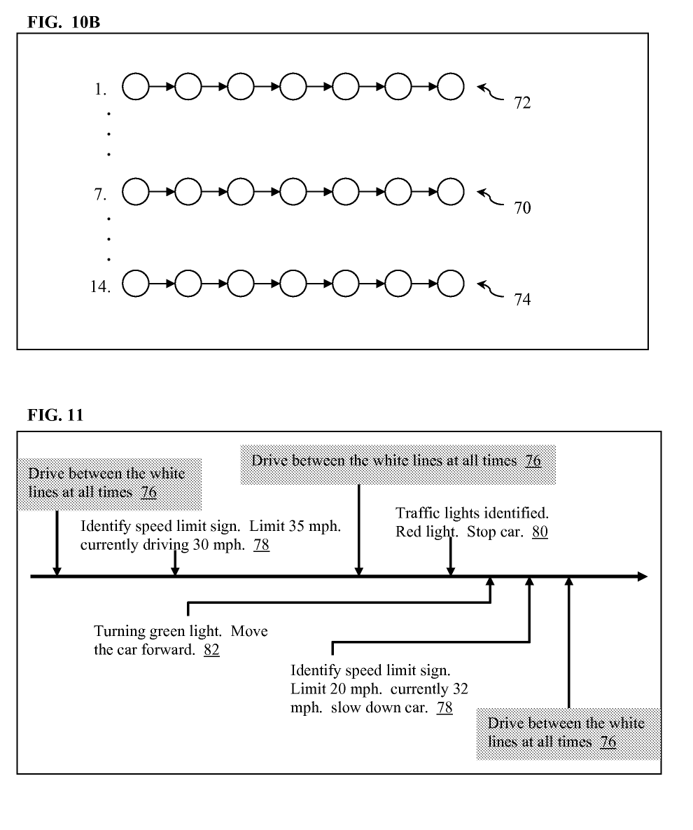

An extension of the last lesson is to include task sequences. If one task in the event pool occurs there might be a high probability that a sequence of tasks will occur in the future. This is why task sequences are also included in the event pool—when a task does occur the AI program can anticipate what sequence of events will occur next. To make things even more complex, if one task in the event pool is recognized then there might be a group of unpredictable tasks that might or might not happen in the future. Thus, task sequences can also have universal pathways for each task. FIG. 10A shows an illustration of a task sequence 70 containing 2 universal future pathways. Each universal future pathway can have its own event pool. To make future predictions more accurate only unpredictable tasks use universal future pathways. Most future pathways predicted should contain the time or estimated time each task will occur.

Continuous tasks and multiple tasks—FIG. 11 shows an illustration of a pathway that contain a continuous task and multiple tasks. Task 76 is continuous because the robot is always watching the road and driving between the two lines. In the event pool, task 76 is located there and assigned a continuous time. This means that at all times during a time domain, task 76 is being followed by the robot. Execution of task 76 will occur at intervals and continuously based on past experiences. At the same time that task 76 is being followed continuously it will also be aware of task 78, task 80, and task 82. These tasks may or may not happen and the timing of their occurrence is unpredictable.

Loops and patterns—If a task has a looping pattern then the AI program will attach this information with the task. This can also happen with tasks in task sequences. The AI program will find simple patterns in tasks such as loops and next-task loops. More complex patterns are not found by comparing similar examples, but are embedded in words and sentences. By using words and sentences to represent a task or task sequence the patterns are innately contained in the meaning of words and sentences. Words and sentences can also represent time or to represent when certain tasks will occur.

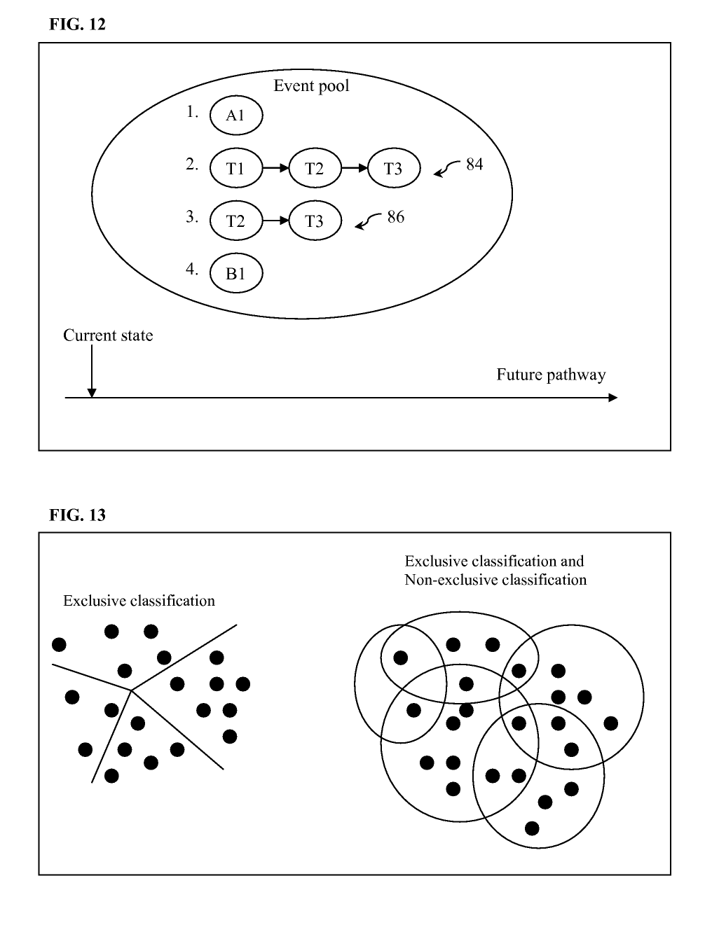

Tasks and task sequences in the event pool will be structured in a hierarchical manner, wherein the most frequently occurring task or task sequence will be outlined. This will help the AI program predict which tasks or task sequences will most likely occur and which are least likely to occur. However, most tasks and task sequences are still unpredictable. Referring to FIG. 12, the tasks and task sequences are arranged in a hierarchical manner, wherein the list will contain the highest frequency of task occurrence. Also, tasks 86, which is encased in task sequence 84, can also be included in the event pool.

There are two types of future pathways: (1) Linear pathways which are pathways that have only one future possible sequence. (2) Universal future pathways which are pathways that have many possible future outcomes. Both linear future pathways and universal future pathways will be used in combinations to predict the future. Only unpredictable outcomes use universal future pathways. Linear future pathways are preferred because they give the AI program a detail future pathway with exact tasks and time these tasks will occur. The idea is to predict the future accurately and precisely and list the most dominant future pathways. As new data is encountered by the robot the list will update itself. FIG. 10A is a diagram depicting a tree-like structure of future pathways using both linear and universal future pathways. FIG. 10B show the ranking of the most dominant future pathways in the tree.

Commonality Groups and Learned Groups

Data in memory is not totally based on association. In the AI program there are two different groups: commonality groups and learned groups. Commonality groups are physical and non-physical traits that two objects have in common (for simplicity purposes only visual objects will be used). Men and women are similar in that they have two legs, two arms, one head and a body. Commonality groups comprises: 5 sense objects such as sight, sound, taste, touch and smell, hidden objects in each sense, activated element objects, instructions that control the robots body, pattern objects and a combination of all objects mentioned. Learned groups are objects that are learned to be the same and might or might not have any physical traits in common. Language is the main source to represent learned groups. Learned groups are visual objects that are classified to be the same. A mouse and a monkey look different but we classify them as animals. The learned group animal will identify the mouse and the monkey to be the same object.

Both commonality groups and learned groups must co-exist in the same 3-dimensional storage space (or 3-d memory). Commonality groups are considered classifying data in terms of association. By introducing the learned groups, data in memory will turn “chaotic”. Multiple copies of the same object will be stored in memory and association between visual objects will only occur in limited sections in memory.

Traditional classification methods will not be used. The popular Euclidean distance is not used because the data in memory are not uniformly associated. A section in memory might be associational in manner, but a few distances away are sections of data that have totally different common traits. One example are animal images—right next to mouse images are various monkey images. A learned group put the monkey images right next to the mouse images because they are classified as animals.

Traditional classification method such as putting the data in a 2-dimensional vector is also not used. The data is put in a 3-dimensional grid. The third dimension, which is distance/focus and direction is added (this is for visual objects and other senses such as sound and touch). Classification is also done in a non-exclusive manner. FIG. 13 shows an illustration of data classification done using exclusive groupings, while the HAI program classify data using exclusive and non-exclusive groupings.

One of the hardest problems facing this AI program was designing the commonality groups. If data is distributed in a chaotic manner the Euclidean distance is not used. If the Euclidean distance is not used then how do we know if two objects have common traits? I use sets, intersections, unions and complements to solve this problem. The association between two visual object is not determined by its distance, but by an approximate distance (this is done by grouping and shifting visual objects around). After determining the optimal area to store the current pathway (or encapsulated tree), the AI program will generate different commonality groups for each visual object in the encapsulated tree (herein called diverse commonality groups). For each visual object in the encapsulated tree a fuzzy range will be created and serves as a measurement when comparing neighbor commonality groups or individual visual objects. The data contained in each commonality group in memory will also be changed based on said visual object—Data such as the boundaries of the commonality group and the average object in the commonality group.

After self-organization, the most important commonality groups are created and the least important commonality groups are not created in the optimal area where the visual object was stored. If you think about all the permutations and combinations of sets and how to group elements in sets, the possible groups can run exponentially as more elements are added into different sets. The purpose of self-organization is to store the visual object in the most optimal area in memory and at the same time limit the commonality groups to the most important groups. However, the amount of commonality groups has to be sufficient enough to organize data.

Data Structure of a Commonality Group

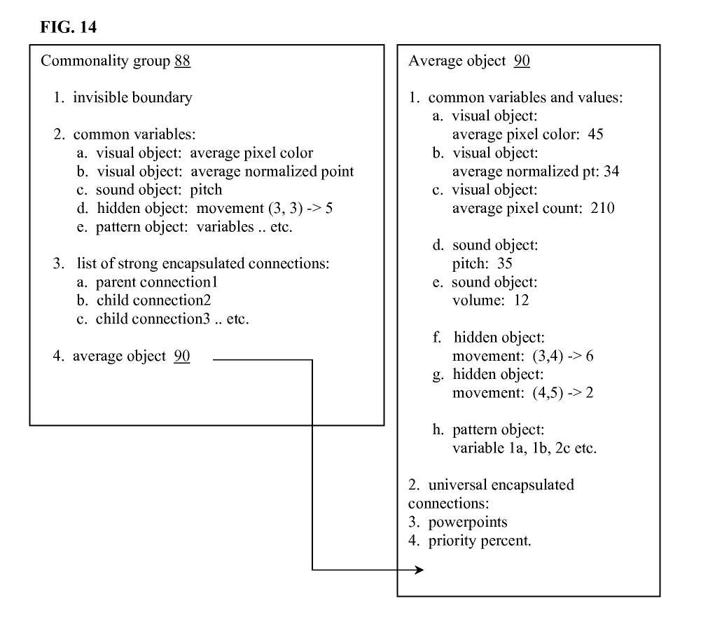

For simplicity purposes all objects will be called visual objects. FIG. 14 is a block diagram of a commonality group 88. Each commonality group 88 comprises: an invisible boundary, common variables from all visual objects, a listing of strongest encapsulated connections and an average object 90. The average object 90 is located in the center of the commonality group 88 and is considered a secondary object. It is equivalent to a real visual object, but the only catch is that it contains the average information from all visual objects in commonality group 88. The encapsulated connections are given by the strongest visual objects in commonality group 88. Each variable in the commonality group 88 will also have a range—a low and a high. Average object 90 comprises: the average common variables and values that all visual objects in the commonality group share, universal encapsulated connections, a powerpoint and a priority percent.

Referring to FIG. 14, the common variables in commonality group 88 is different from the common variables in average object 90. The common variables are traits that all visual objects have in commonality group 88. The common variables and values in average object 90 come from the majority of variables from all visual objects in commonality group 88—some of the visual objects in commonality group 88 may not contain these variables, but the majority of visual objects in commonality group 88 contain these variables.

The search function will be using average objects in commonality groups to search for matches quicker. Average objects contain the average values of a group of visual objects. The AI program will search for the strongest commonality groups first, then search for the weaker commonality groups and finally search for individual visual objects.

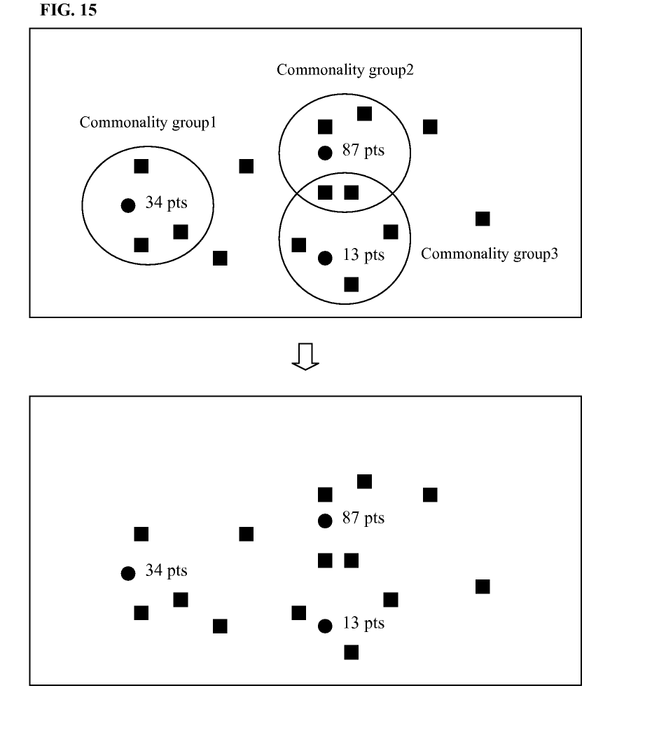

In FIG. 15, each commonality group is represented by their average object. The strength of the commonality group is also represented by the strength of the average object. When the search function searches for data it will look at the strongest average objects first before moving on to the least strongest average objects. Finally, the individual visual objects are compared and the search function should triangulate an optimal area to store the input data (the visual object). In FIG. 15, the black dots are average objects and the number next to it is the strength of that average object. The black squares represent individual visual objects.

As noted before, average objects are considered secondary objects and acts just like ordinary visual objects. Average objects are used by the search functions because they represent the average of a group of visual objects. Thus, regardless of how many data is stored in memory (even infinite data) the search function can shrink the network space into manageable search areas.

After searching for the best matches for the input data the input data will be stored in an optimal area in memory. This optimal area is only an estimated area. The self-organization function will determine a more exact area to store the input data.

Self-Organization Steps

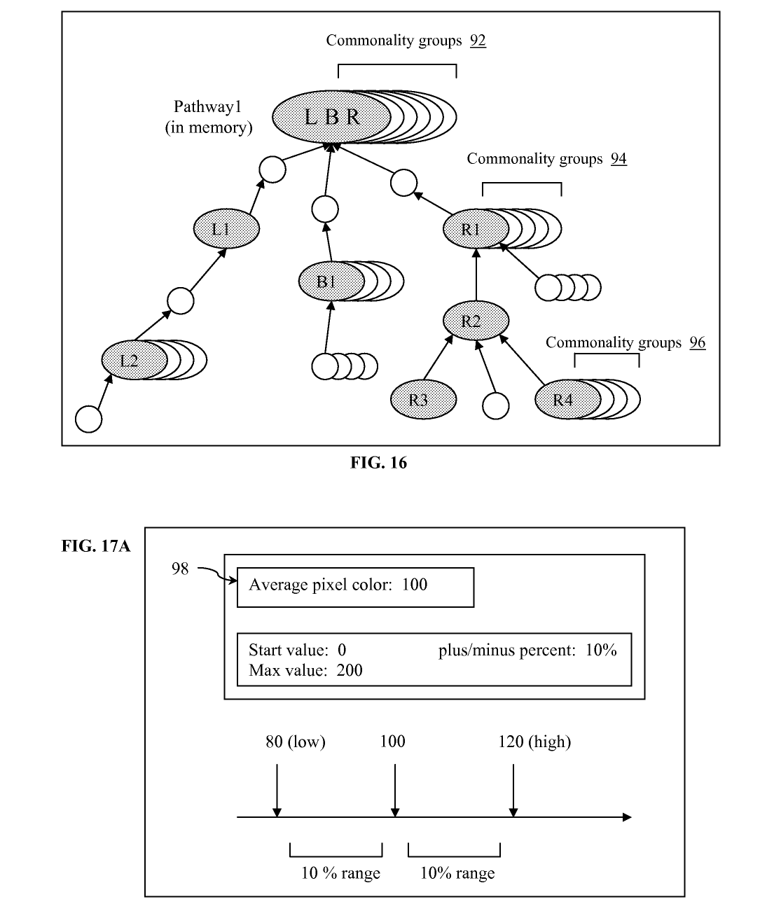

Referring to FIG. 16, after the search function is over and the AI program generates an optimal encapsulated tree for the current pathway, the entire tree will prepare to self-organize itself in memory. The search function designates which visual objects in the tree are stored in which areas. Because we want to create a fuzzy range of each visual object the AI program has to generate many different commonality groups for each visual object in the optimal encapsulated tree (herein called diverse commonality groups). These diverse commonality groups will serve as a measurement to determine how similar a visual object is compared to all its neighbors (this is an alternative method to the Euclidean distance). First, the AI program generates random or guided commonality groups on each visual object starting from the root node (the current pathway). All or most of the visual objects will go through this process. In FIG. 16, visual object LBR generates diverse commonality groups 92, visual object R1 generates diverse commonality groups 94 and visual object R4 generates diverse commonality groups 96.

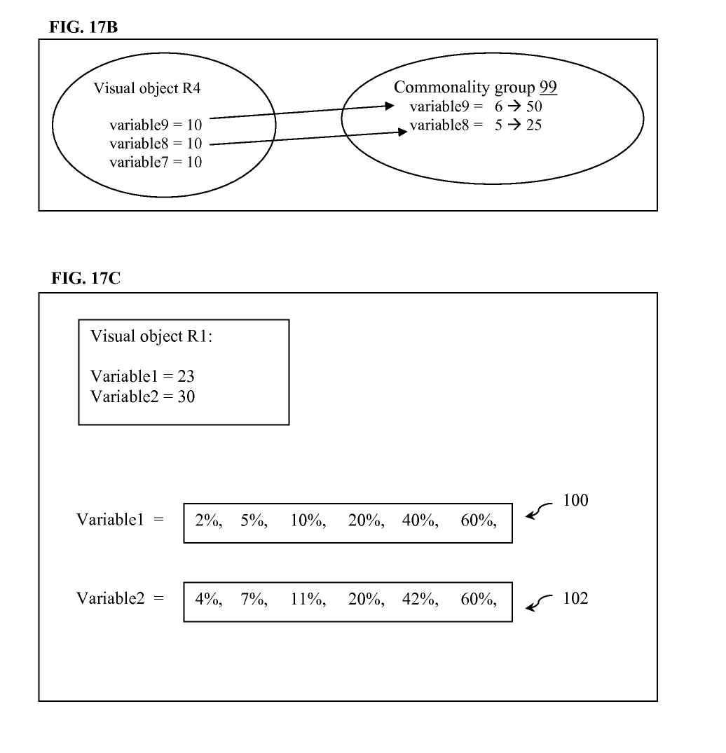

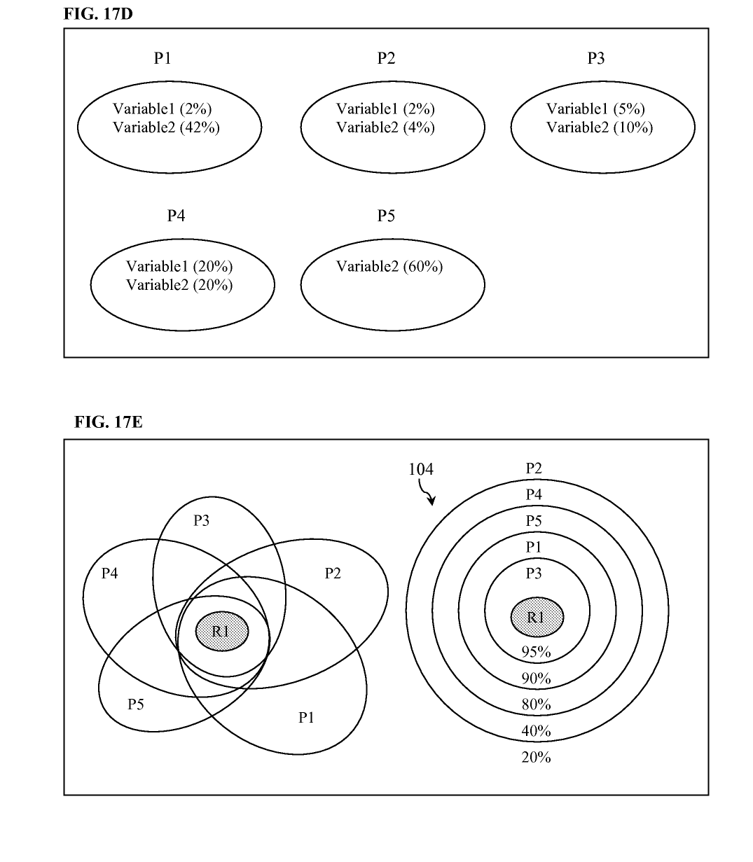

Referring to FIG. 17A-D, the diverse commonality groups of visual object R1 is generated by taking the variables of visual object R1 and setting a high value and a low value on each variable and stringing variables together in groups of permutations and combinations based on random grouping, self-guided grouping or predefined grouping of the variables. The highs and lows of a variable in visual object R1 are set by a plus/minus percent from a given variable value. The start value and the maximum value of a given variable will determine the benchmark of the plus/minus percent. For example, in FIG. 17A, variable 98 has a value of 100. The start value is 0, the maximum value is 200 and the plus/minus percent is set at 10%. This means the low value of variable 98 is 80 and the high value is 120. Any variable value that falls between 80 and 120 will qualify as a match for that variable. In order for a visual object to qualify in a commonality group, variables in the visual object must match to “all” common variables in the commonality group. In FIG. 17B, visual object R4 qualifies in commonality group 99 because variables in visual object R4 match all common variables in commonality group 99. Match in this case means each variable's value fall in the range of their respective common variable.

The highs and lows of a variable are set based on a mathematical spaced out plus/minus percent. Some examples of plus/minus percents are: 2%, 5%, 10%, 20%, 40%, 60%, 90% or 2%, 3%, 5%, 8%, 10%, 15%, 20%. More commonality groups will be created closest to the variable value of the visual object. The more similar the variable value, the more diverse commonality groups will be created and the more dissimilar the variable value is, the less diverse commonality groups will be created. After determining the plus/minus percents that will be used for each variable, a process of grouping variables with different plus/minus percents will occur. A mathematical equation will determine the permutation and combination groupings of different variables with different plus/minus percents.

Referring to FIG. 17C, visual object R1 has 2 variables: variable1 and variable2. There plus/minus percents are created for each variable (block 100 and block 102). Referring to FIG. 17D, using a mathematical equation the AI program created diverse commonality groups P1-P5 (in real world situation a visual object might generate 100's or thousands of diverse commonality groups depending on what that visual object is). Commonality group P5 has only one variable in the group. These diverse commonality groups generated by visual object R1 serves as a fuzzy range (or measurement) to compare with other visual objects in its neighbor. Referring to FIG. 17E, diagram 104 shows the fuzzy range of visual object R1. The AI program will generate more diverse commonality groups that are similar to visual object R1 (95%, 90% or 80%). However, it will also generate diverse commonality groups that are not similar, but have some common traits (40% or 20%).

Now that a fuzzy range has been established for visual object R1, visual object R1 will compare all its diverse commonality groups with the closest neighbor commonality groups. If a diverse commonality group is the same or similar to a neighbor commonality group they will share the same group. The commonality group that is similar or same to the diverse commonality group will strengthen and visual object R1 will be inserted. The commonality group will stretch its boundary to include visual object R1. Thus, all visual objects in the commonality group are brought closer to visual object R1. If a given diverse commonality group doesn't have a match in its surroundings, that diverse commonality group will be created (newly-created diverse commonality groups only have visual object R1 has an element).

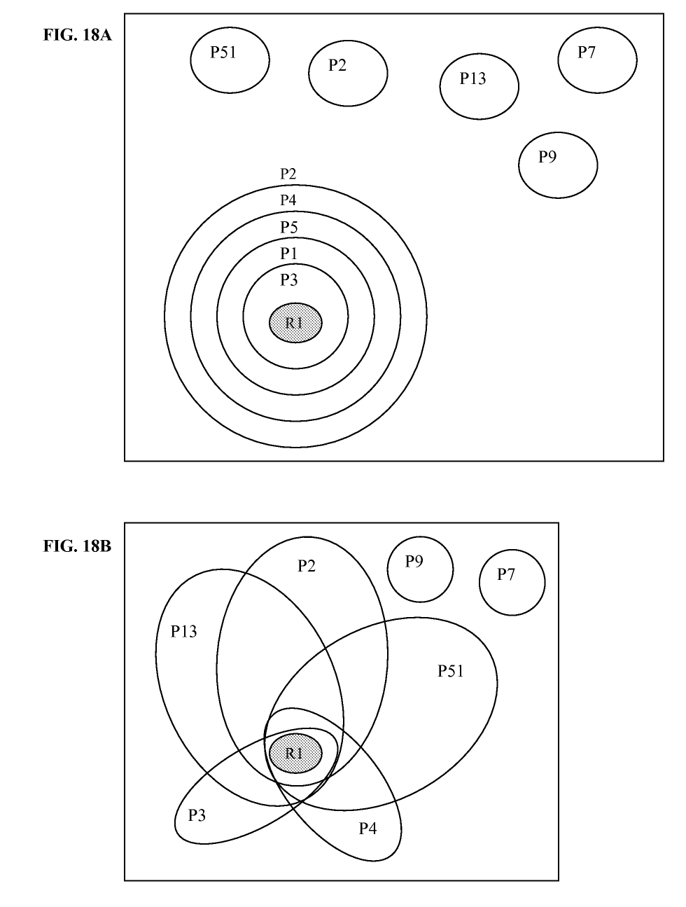

Referring to FIG. 18A, the diagram shows visual object R1 and its diverse commonality groups: P1-P5. The commonality groups in memory: P51, P2, P13, P7 and P9 surrounds visual object R1. FIG. 18B is a diagram showing how diverse commonality groups find matches in its surrounding areas. If commonality groups are matched with diverse commonality groups then the commonality groups will be strengthened and visual object R1 will be inserted into that commonality group. The commonality group will stretch its boundaries to include visual object R1. Commonality groups can also be matched with similar diverse commonality groups. Diverse Commonality group P2 is the only group that has found a match. Diverse commonality groups: P5 and P1 are similar matches to commonality groups: P51 and P13 respectively. Because they are similar they are still considered matches.

Next, diverse commonality groups that have not found matches such as P3 and P4 will be newly created in memory. In FIG. 18B commonality groups P3 and P4 are created and surrounds visual object R1. Commonality groups P9 and P7 have no common traits with visual object R1 so it doesn't surround visual object R1. Because commonality groups P9 and P7 have relations to other groups it is pulled toward visual object R1 just a little.

### Commonality Groups Pull Visual Objects Together

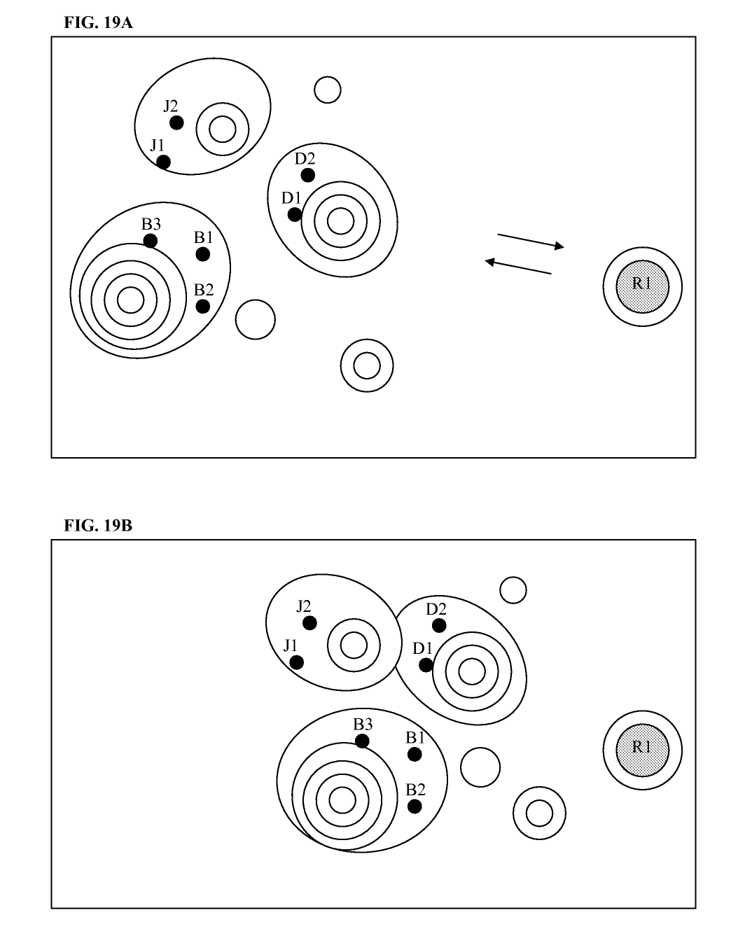

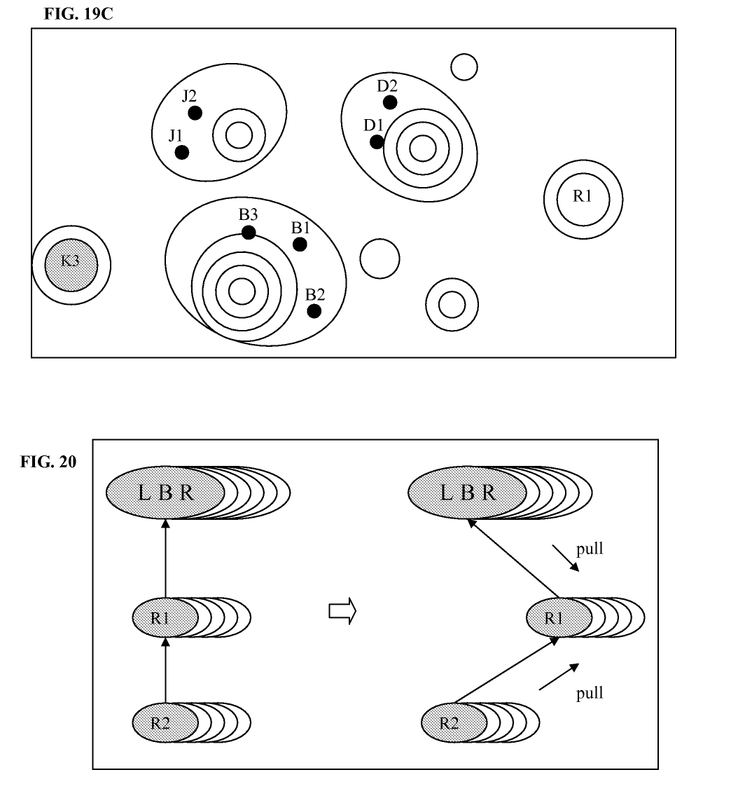

If there are common traits between two or more visual objects they will be pulled towards each other based on their commonality groups. The more common groups two visual object has with each other the stronger the pull. Referring to FIG. 19A, visual object R1 is stored in memory and it has common traits with commonality group D, J and B. The commonality groups D, J and B will gravitate towards visual object R1. The visual objects in each commonality group will also be pulled towards R1. This would include visual objects D1, D2, J1, J2, B1, B2, and B3. FIG. 19B shows what the data looks like after self-organization. Notice the boundary of each commonality group has been stretched because of the pulling affect. The elements (or visual objects) in each commonality group are also pulled toward visual object R1.

Referring to FIG. 19C, visual object K3 is newly stored in memory. All commonality groups matched with visual object K3's fuzzy range will be brought closer to visual object K3. The commonality group J and B have similarities with visual object K3 so they are brought closer to visual object K3. However, commonality group D has little or no common traits with visual object K3 so it doesn't get pulled toward K3 as much as the other two groups. Because commonality group D has relations with commonality groups J and B, commonality group D is brought closer to visual object K3. When commonality groups (J and B) are pulled toward visual object K3, its dependants (commonality group D) is also brought closer to visual object K3. Notice also that visual object R1 is brought closer to K3. The association between visual object R1 and the other commonality groups pulled visual object R1 slightly toward visual object K3.

FIGS. 19A-C demonstrates that visual objects can be “pulled” together or it can “pull apart” from each other. Association between objects in memory is based on these two opposite forces.

Pulling Encapsulated Objects Together

Association between two or more objects doesn't just apply to objects in memory, but encapsulated objects. FIG. 20 is an illustration showing how visual object R1 is being pulled towards its associated area. While this is happening parent encapsulated object LBR and child encapsulated object R2 are also being pulled towards visual object R1,

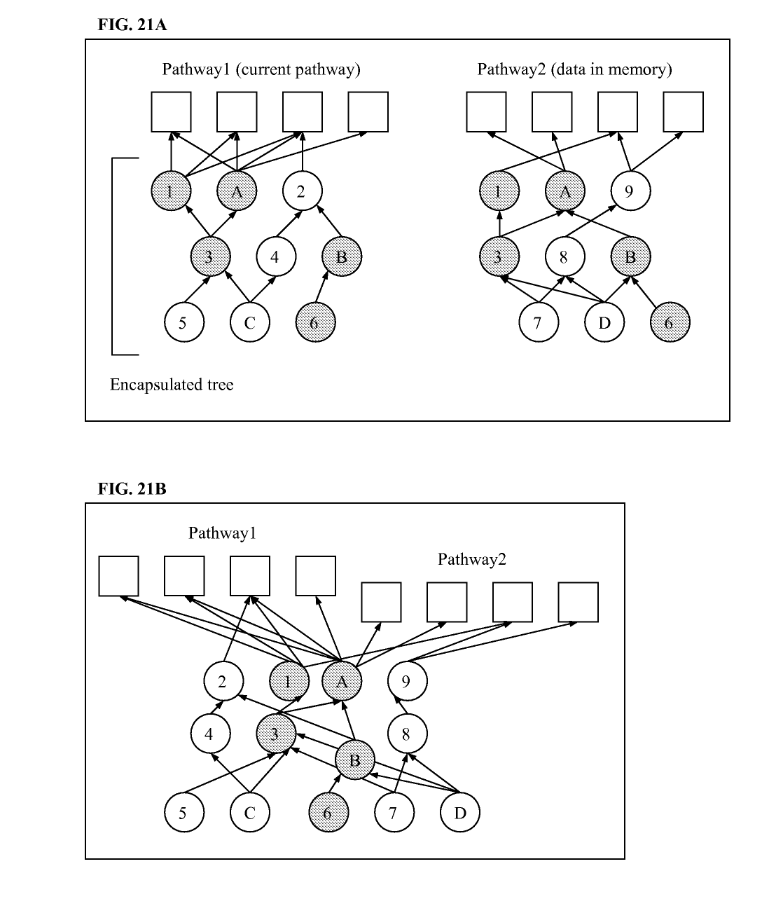

Each visual object and its fuzzy range will create association between pathway LBR (or encapsulated tree) and other pathways in memory. The fuzzy range of a visual object is the commonality groups and learned groups stored in memory. Referring to FIG. 21A-B, pathway1 self-organizes itself with pathway2 in memory based on their encapsulated tree and their fuzzy range. This fuzzy range is not generated after the optimal encapsulated tree is created, but after self-organization. The fuzzy range defines where pathway1 will be stored. In a dynamic environment the current pathway self-organizes itself with thousands of other pathways in memory. A human being, for example, has to self-organize itself with thousands of similar human beings. Women are organized with women and men are organized with men, but at the same time their commonality groups also has to be strengthened. For example, a human object is created from the common traits of men objects and women objects.

Universalize Pathways

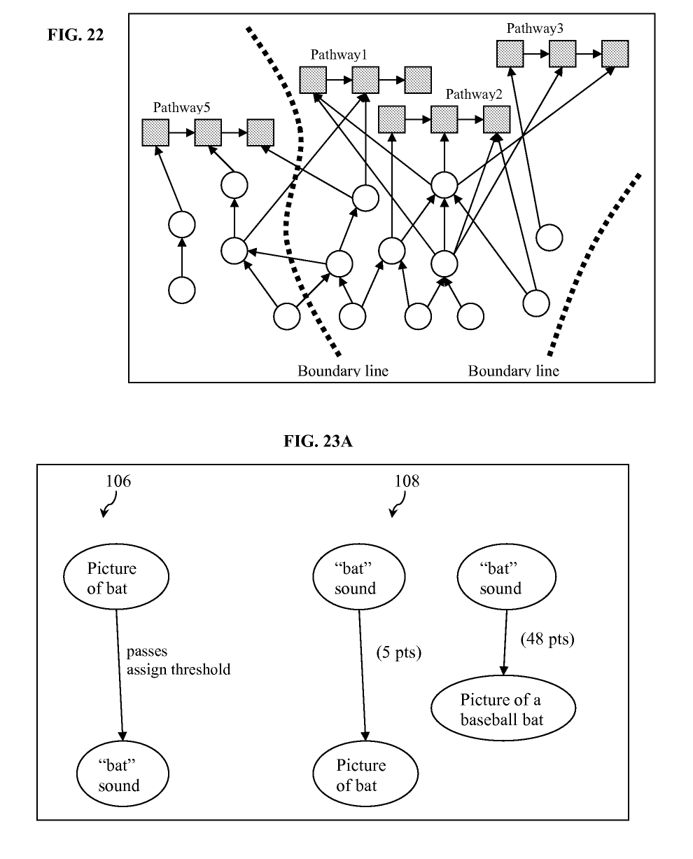

After pathways self-organize itself in memory, the next step is to universal pathways (or encapsulated trees) in memory. FIG. 22 is an illustration of a universal pathway. Pathway1 pathway2 and pathway3 are grouped together as one universal pathway. This universal pathway is created based on commonality groups and learned groups shared by all three pathways. As all three pathways get stronger and stronger they will break away from surrounding pathways creating a universal pathway. This topic is discussed in detail in patent application Ser. No. 11/936,725.

Forgetting Commonality Groups

The diverse commonality groups generated by the visual object are necessary to bring associated visual objects together. The computer memory that the commonality groups uses up is substituted by forgetting data. If a commonality group is not used in the future, it will be forgotten and the computer memory used is recycled. However, if more visual objects use a commonality group that group will be stronger and stronger in memory.

For simplicity purposes only visual objects are being used to demonstrate commonality groups. In real world situations commonality groups will include the 4 different data types in combinations: 5 sense objects, hidden objects, activated element objects, and pattern objects. For example, sound objects can have common traits that relate to sound traits such as pitch, volume, tone, and all the different sound traits that are currently being used. Each object must have the common traits for each data type in order to be included in that commonality group. Referring to FIG. 14, commonality group 88 comprises: a visual object with two common variables: average pixel color and average normalized point, a sound object with one common variable: pitch, a hidden object with one common trait: movement; and a pattern object. Any object in a given radius that has these different data types and common traits will be grouped together in commonality group 88.

Learned Groups

Humans classify objects, actions and situations based on language. Language brings order to chaos. This is why it is so important that the AI program has the ability of not only associating common traits, but also the ability of associating learned traits. We learned that a rat and a horse are animals. Although both the rat and the horse look totally different, we classify these two objects as animals. Because we learned that these two objects are animals they are classified as the same objects. When a car accident occurs, witnesses to the car accident can see the accident from any angle and distance. Even though the movie sequences of the accident is different from different angles and distances, they are all classified as a car accident. The actual car accident can be different as well and the words “car accident” will classify the event perfectly.

The AI program will use the rules program to associate one object with another object in memory. Association between two objects is based on two factors: (1) the more times two objects are trained together the stronger the association. (2) the closer the timing of the two objects are trained the stronger the association. For example, if we show the robot a picture of a bat and say the words “bat”, the robot will associate the sound “bat” with the picture of a bat.

Referring to FIG. 23A, imagine that the training occurs at the exact area in memory and objects in similar pathways have slight variations. Objects become stronger after training; and the stronger they are the more gravity pull they have with other objects in memory. After many training, the sound “bat” and the picture of a bat will gravitate towards each other. Weak objects located around the sound “bat” will have weak association with the sound “bat” even if its near-by. FIG. 23A shows each object having different association with different objects and vice versa. Association works bidirectional and linearly. In diagram 106, the picture of bat will activate the sound “bat”. However, in the opposite direction (diagram 108), the sound “bat” has multiple copies in memory and if the sound “bat” is the target object then the strongest element object from all copies of the target object will compete to be activated. The result is: the sound “bat” will activate a picture of a baseball bat and not the picture of a bird bat.

The fuzzy range of an object should also to be considered. The text word “computer” is made up of a movie sequence identifying individual letter or letters. The various movie sequences of recognizing “computer” from the environment can be infinite—we can read the text “computer” on a book, on a computer, on a wall, on a magazine, on a chalkboard or on the floor. The font color and size of the text “computer” can be anything—the text can be arranged using chopsticks, the text can be displayed in the sky, or any various way of expressing the text “computer”. Only the letters that make up the text “computer” will be recorded in the sequence—the image processor will cut out the letters from the movie sequence and filter out the noise. The underline average data of all training examples for the text “computer” will get stronger and stronger. Referring to FIG. 23B, the average is the center of the movie sequence and the fuzzy range surrounds the center. New movie sequences that are stored will self-organize itself in the floater. Depending on where the new movie sequence is stored, different data in the floater gets stronger. Where ever the new movie sequence is stored the average of the floater will also get stronger and stronger.

The last method is also used in associating two objects (each object has a fuzzy range of itself and is called a floater). Referring to FIG. 23B, the text word “bat” (B1) is stored in the text floater 110. Because B1 is stored in floater 110 the center of the floater gets stronger. This will increase floater's 110 gravitational pull and will bring the pictures of bats 112 closer to floater 110.

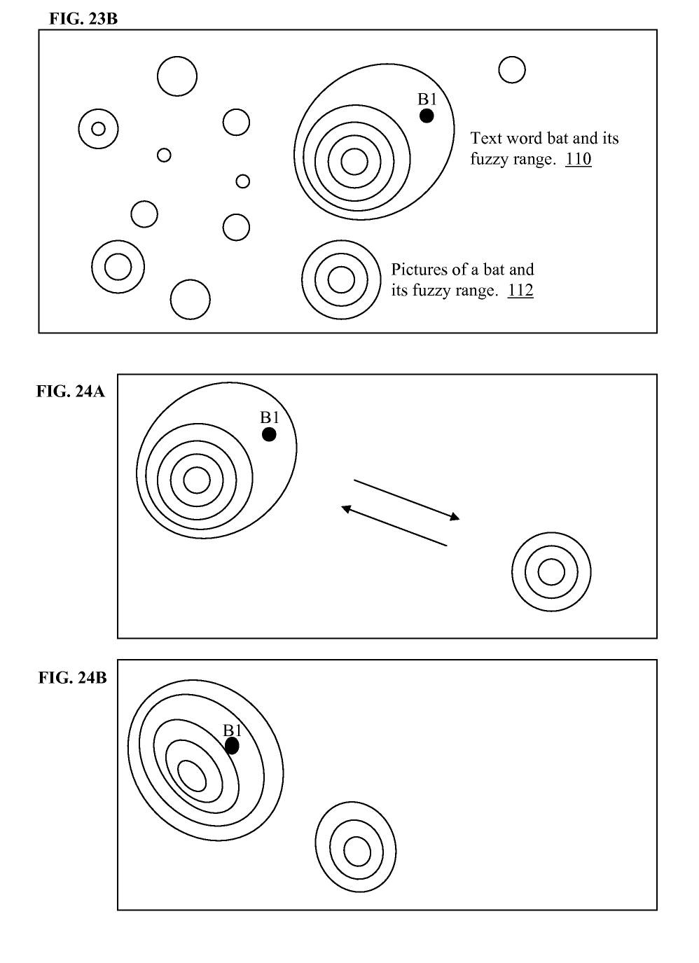

Referring to FIG. 24A-24B, when floaters gravitate towards each other, the floater will change its shape by the pulling affect. The strongest relations to other objects will be pulled first. This will pull any depending objects (most notably its fuzzy range).

Any given object can have many variations in terms of words. A human object has many hierarchical learned groups such as man, women, human being, child, old man, teenager, baby, fat man, skinny man, sexy women, fat women, short person, tall person and so forth. All these learned groups will be stored in the human object and both learned traits and common traits will self-organize in the same area.

How Floaters are Created from Movie Sequences

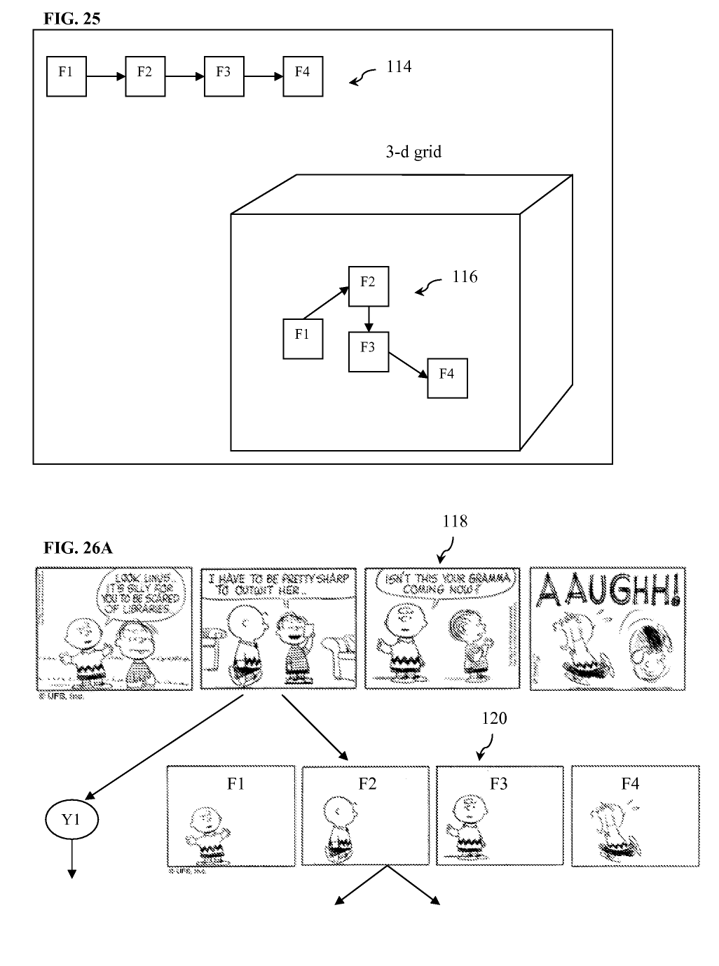

Referring to FIG. 25, movie sequences are stored not in a linear way, but in a 3-dimensional way where the position of each frame is based on distance and direction. Movie sequence 114 is arranged in memory shown by pointer 116. The distance and direction of each frame is stored according to how the AI program interprets the distance and direction of the environment.

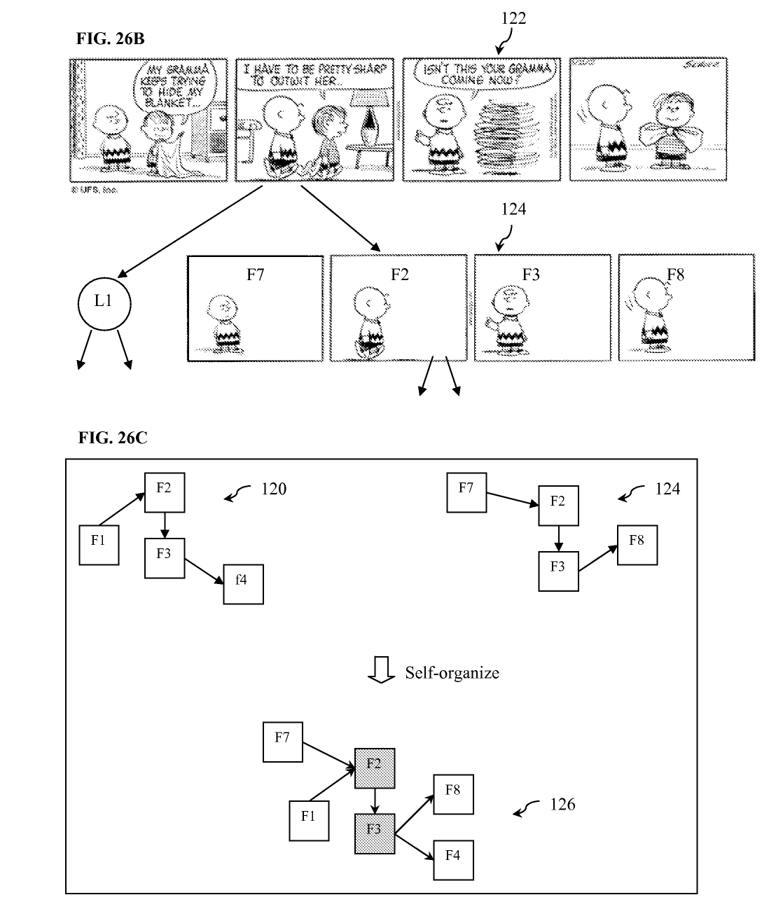

FIGS. 26A-C are illustrations depicting how same object floaters merge together. In memory there can be many same object floaters. Object floaters that have common traits with other object floaters will merge together during self-organization. A radius will be defined and any object floaters that have common traits will gravitate towards each other. FIG. 26A shows current pathway 118 broken down into its encapsulated tree. Movie sequence 120 is a Charlie brown floater and contains sequential images of Charlie brown cut out from movie sequence 118. FIG. 26B shows current pathway 122 broken down into its encapsulated tree. Movie sequence 124 is another Charlie brown floater and contains sequential images of Charlie brown cut out from movie sequence 122. If movie sequence 120 is stored near movie sequence 124 then their common traits will gravitate towards each other. Referring to FIG. 26C, F2 and F3 are common frames between movie sequence 120 and movie sequence 124, therefore, they will gravitate towards each other. Because F2 and F3 are exact matches they will merge together and both movie sequences will share one copy. Floater 126 depicts the final Charlie brown floater after self-organization. If F2 and F3 are not exact copies they will be brought closer together based on how similar they are—the more similar they are the closer they will be to each other.

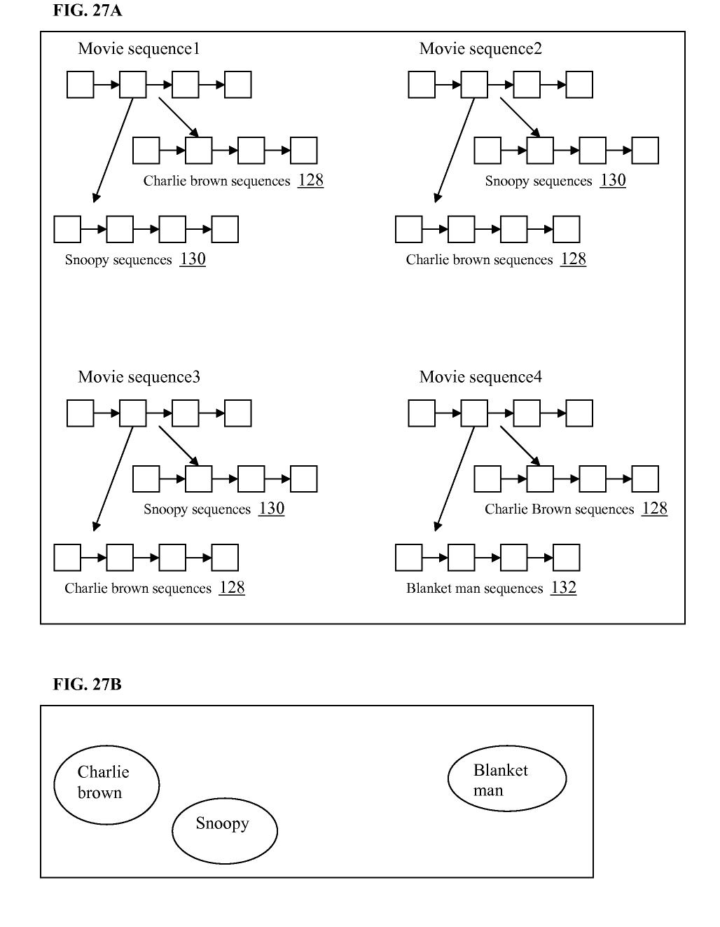

FIGS. 27A-B are diagrams depicting how multiple object floaters self-organize in memory. If movie sequence1-4 and their encapsulated objects are stored near each other in memory then they will self-organize based on common traits (frames). Movie sequences1-3 has Charlie brown 128 and snoopy 130 and only movie sequence4 has Charlie brown 128 and blanket man 132. Referring to FIG. 27B, because Charlie brown 128 and snoopy 130 are encountered 3 times and Charlie brown 128 and blanket man 132 is encountered only once, the snoopy floater will be closer to the Charlie brown floater and the blanket man floater will be farther away from the Charlie brown floater.

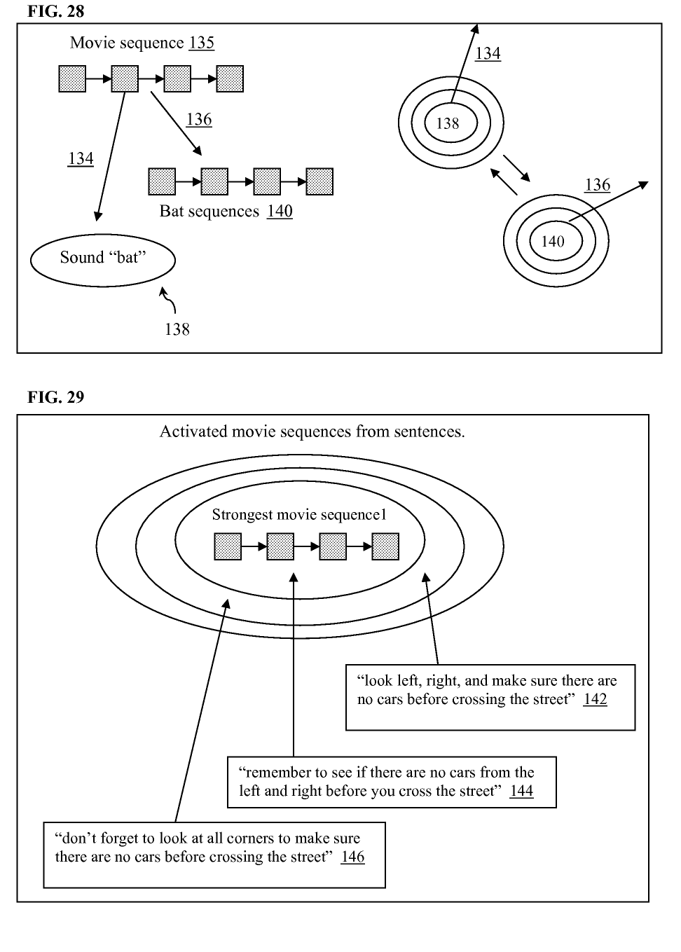

Referring to FIG. 28, encapsulated tree 135 (or movie sequence 135) shows how encapsulated objects gravitate towards each other. The sound “bat” 138 and the bat sequence 140 are encapsulated in encapsulated tree 135. When encapsulated tree 135 is stored in memory, the sound “bat” 138 and its fuzzy range will gravitate towards bat sequence 140 and its fuzzy range. Notice also that encapsulated connections 134 and encapsulated connections 136 is still connected to their respective object.

Referring to FIG. 29, when sentences are recognized by the AI program, wither its sound sentences or visual text sentences, the meaning will activate in the AI program's mind. This meaning will be in the form of a fabricated movie activated by each sentence. As more examples are trained the fabricated movies will get stronger and stronger creating a floater. This floater will contain the average fabricated movies activated by different sentences. As the floater gets stronger and stronger, the sentences that activated the fabricated movies will get closer and closer to the floater. When data self-organizes itself, the floater of the fabricated movies will bring all the sentences that activated it closer together. This is how sentences in memory are represented in terms of fuzzy logic. We can say different sentences, but the sentences can mean the same things. Sentence 142, sentence 144 and sentence 146 are brought closer to each other because they activate similar fabricated movies.

Self-Organizing Commonality Groups and Learned Groups

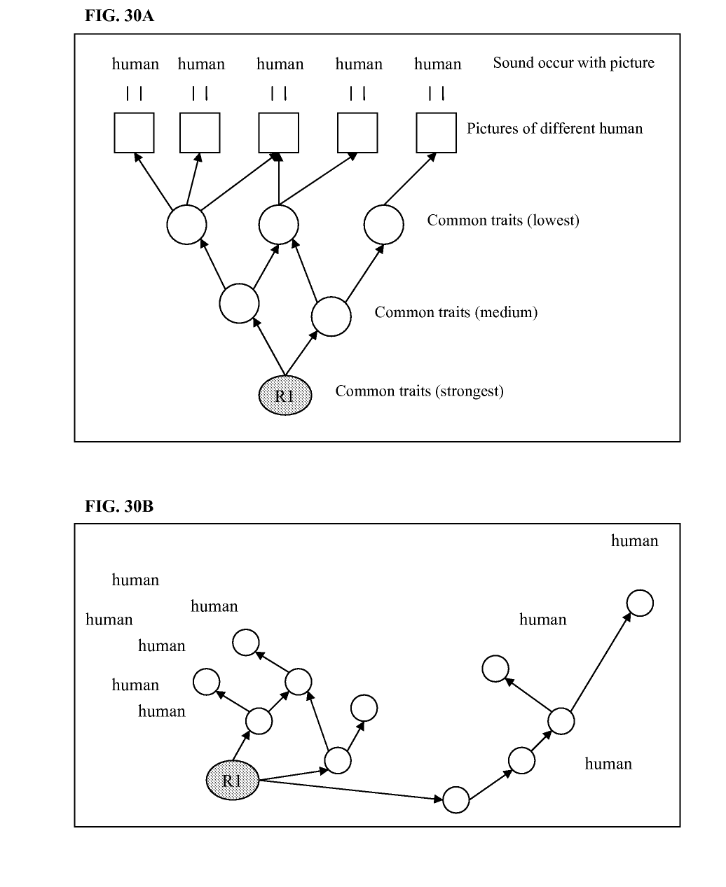

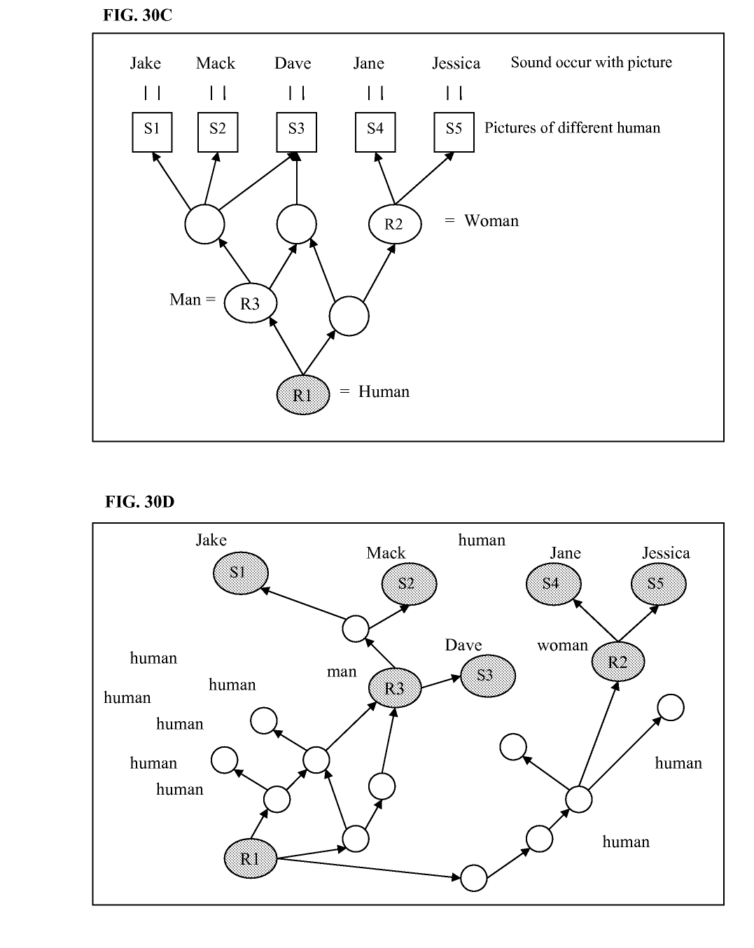

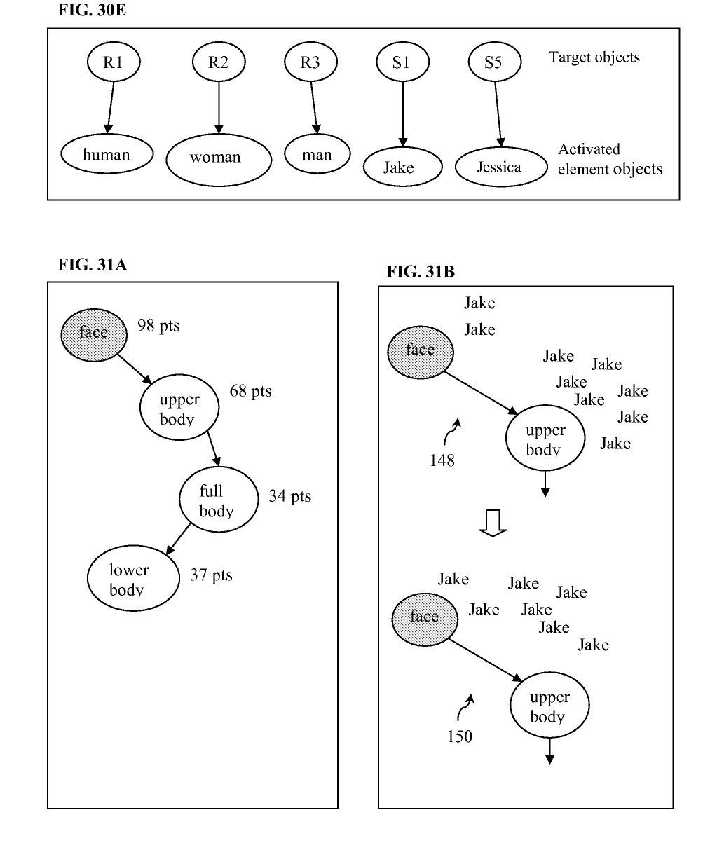

Learned groups are created by language. Words and sentences in a language will group visual objects together based on what we classify as same visual objects. Teachers will point to a picture of a man and say this is a human, then the teacher will point to a picture of a woman and say this is a human, then the teacher will point to a picture of a teenager and say this is a human and finally the teacher will point to a picture of a child and say this is a human. These pictures all look different, but because the word human was said during the time the pictures were recognized each image will have strong association to the word human. The word human will then bring all the different pictures closer to one another. Commonality groups will be created based on common traits between all pictures. Each commonality group will have an average object that represent the average of all visual objects contained in the commonality group. Referring to FIG. 30A, the commonality groups will range from the strongest common traits to the low level common traits. The strongest common traits is designated by R1. Referring to FIG. 30B, the word human (a learned group) will bring any visual object including average objects in commonality groups closer to the strongest location of the words “human”. In this case, R1 gravitates toward the strongest location of the words “human”. The end result is strong association between the word human and R1. If the AI program encounters a visual object similar to a human, it will be stored near R1 and the sound “human” will activate in the robot's mind.

To make things more complex, hierarchical words related to the word human will be used. The hiearchical words related to the word human would include: specific names, man, and woman. The AI program will associate same pictures with different words by lessons from teachers. The teacher will teach the robot the specific name for each picture. FIG. 30C is a diagram of specific names given to different pictures (Jake, Mack, Dave, Jane and Jessica). Next, the teacher will use the same pictures and associate gender words with each picture. For example, the teacher will show a picture of Jake and say: this is a man, or the teacher will show a picture of Jane and say: this is a woman. Finally, the teacher will use the same pictures and associate classification words. In this case each picture will be associated with the word human.

All this information will be stored in memory and self-organization will bring different learned words closer towards the visual object that has the strongest association. During self-organization commonality groups will be created (or strengthened) and each commonality group will have an average object. Each average object will also gravitate towards the learned word that has the strongest association. Referring to FIG. 30C, average object R2 has strong association with the word woman, R3 has strong association with the word man and R1 has strong association with the word human. S1-S5 will be associated with their respective names. Referring to FIG. 30D, visual objects will gravitate towards their strongest commonality groups and learned groups. Common traits are based on physical and non-physical common traits between visual objects. Learned traits are based on words and sentences associated with two or more visual object. R1 will gravitate towards the most concentrated area on the word “human”. R2 will gravitate towards the most concentrated area on the word “woman”. R3 will gravitate towards the most concentrated area on the word “man”. Finally, each picture (S1-S5) will gravitate towards the most concentrated area on specific names.

Referring to FIG. 30E, the 3-d grid is structured in such a manner that when the AI program recognizes a visual object its identification will activate. For example, if picture S1 is the target object the activated element object will be the sound “Jake”. If picture S5 is the target object the activated element object will be the sound “Jessica”. On the other hand, if an unknown picture is encountered and this unknown picture is stationed near R3 then the activated element object will be the sound “man”. If an unknown picture is encountered and this unknown picture is stationed near R1 then the activated element object will be the sound “human”.

Self-Organizing Encapsulated Objects

The learned groups (words) will gravitate towards the strongest encapsulated object in an object floater. In FIG. 31A, the face is the strongest object in a human object. In FIG. 31B, the sound “Jake” is trained mostly with the upper body (pointer 148). However, because the face object is so strong the sound “Jake” is pulled toward the face object (pointer 150). This method is applied to all body parts including the full body. One example to test this method is recalling certain famous people. For example, if I said George Bush, the reader will have an image of George Bush pop in their mind. The image will most likely be a face or an upper body. Rarely will a full body of a person be initially activated.

Referring to FIG. 32, there are two factors that will create more details about an object in memory. The more times an encapsulated object is encountered the more commonality groups are created for that encapsulated object. The more accurate that encapsulated object is the easier it is to identify. Let's use a face for example, the more we encounter different faces the more commonality groups will be created regarding faces. The more accurate and consistent each face is the more likely we can identify that face in the future. A human being can actually remember and identify 100's and thousands of different faces and associate each face with a specific name. The reason for this is because in the lifetime of a human being, he/she has encountered millions and millions of different faces. Because there are so many encounters regarding faces, a large part of the brain is specifically used to store faces. The face storage area also has many commonality groups to classify certain facial features. The consistency and accuracy of faces is also repeated. Each face we encounter doesn't change. Because faces we see are accurate and consistent we are able to association each face with a specific name.

The lower body of a human being isn't very accurate and consistent because people can wear different clothing—people can wear different pants and shoes to cover up the lower body. Because the lower body isn't consistent we can't identify a specific person by looking at their lower body. We might be able to estimate a probable group of people such as man, woman, child, teenager and old man, but we can't pinpoint an exact person. Identifying people by looking at their palm is also impossible. However, if we repeatedly train ourselves to recognize ridges on the palm to identify a person then we can identify specific people by looking at their palm. The more details we have about the palm the more unique certain palms are. Each unique palm can be assigned to certain names.

Activation in Sequential Movies

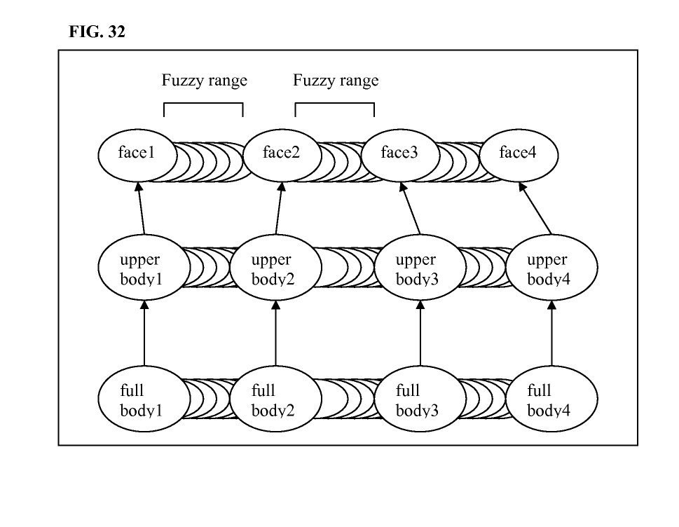

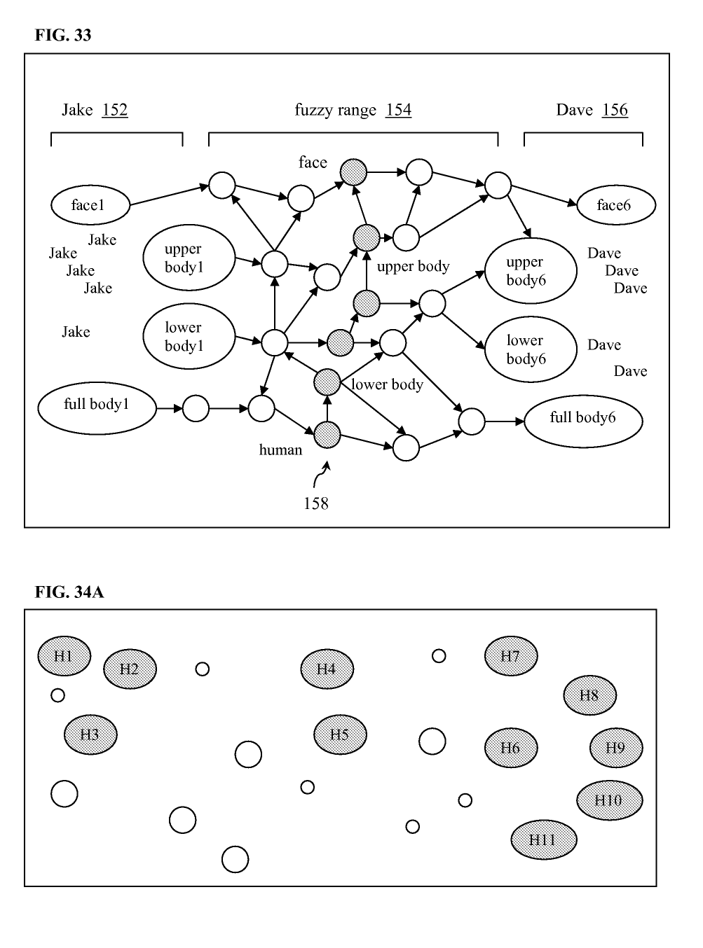

When a human being is encountered visually, each frame sequence of that human being should activate an identification. For example, if a human being is called “Jake” all the sequential frame-by-frame sequences of Jake will activate the sound “Jake”. As discussed above, encapsulated objects are also important; and activation of Jake will greatly depend on what parts of the body the robot is looking at. The face has more importance than the lower body in terms of activating the sound “Jake”. Referring to FIG. 33, the floater of Jake (sequential images of Jake) organizes in one part of memory (pointer 152). The fuzzy range for the floater of Jake, the floater of Dave and all other human floaters is located in pointer 154. This fuzzy range is created by self-organizing commonality groups and learned groups. This fuzzy range also displays the similarities of all human objects and their respective encapsulated objects. The fuzzy range share common traits and learned traits in terms of the face, lower body, upper body and full body. Within the fuzzy range are encapsulated objects shared among many human objects. Encapsulated objects such as elbow, hand, neck, upper body, back, knee, foot and so forth.

This fuzzy range is very important to note because very vague words such as human is not assigned to one specific person, but assigned to many people that share the same common traits. The sound human will be stationed somewhere in the fuzzy range because this word represent many people. Referring to FIG. 33, pointer 154 shows where the strongest common traits are in the human floater. Notice that all the learned words that humans use to classify certain body parts are stationed in pointer 158. The learned words: face, upper body, lower body and human are all positioned near the strongest common traits among many human objects (indicated by grey nodes). If we look at Jake's floater 152 you will notice that the sound objects “Jake” are positioned near the exact frame sequences of the visual object Jake. If we look at Dave's floater 156 you will notice that the sound objects “Dave” are positioned near the exact frame sequences of the visual object Dave. For each person, there respective sound objects are positioned near the face and upper body.

This network tries to associate the best learned words with the best visual objects (or encapsulated objects). However, there is a slight problem in that sometimes the activation of a person doesn't necessarily mean that the name belongs to that person. There are certain rules that people have to use in order to identify people. Some of these rules come from complex logic while others come from simple logic. For example, if a person has 20 different aliases and each name is only used by certain groups of people then the robot has to know these rules. The identification of that person might be one of the 20 aliases, but logic will ultimately determine what name to use to identify that person at a given moment in time. For example, if there was a person by the name of Jessica and she has over 20 different aliases and at different places she is called a different name, then the robot has to know what the rules are in terms of identifying someone. Identification of someone is a learned thing and many years of learning is required to identify someone using logic. These are the rules of identifying Jessica: If Jessica is at school she is called Jessica, if Jessica is at home she is called Jessy, if Jessica is at church she is called Jane, if Jessica is with close friends she is called JC, if Jessica is with regular friends she is called Janel, if Jessica is with extended family she is called princes, etc, etc, etc. The conscious will build intelligent pathways to learn the rules of identifying a person, activating these rules at certain locations and assigning a name to a specific object.

The network can also activate names for Jessica in hierarchical order such as: Jessica→Jane→JC→girl→female→human. The identifications will be activated based on their association with the visual object Jessica. Jessica is the strongest so that activates first, then its JC, next its girl, next it's female, and finally its human. This form of activation, wherein the AI program activates the strongest information about an object can be used as facts to come up with logical thoughts. For example, if someone asks the robot, do you see a mammal in front of you? If Jessica is 3 yards away, the robot will activate facts about Jessica upon seeing Jessica. The robot can reason that mammal is derived from human and the word mammal is located near human in memory. This will prompt the robot to identify Jessica as a mammal. The robot's final response would be: Jessica is a mammal.

Many Copies of the Same Object Floater in Memory

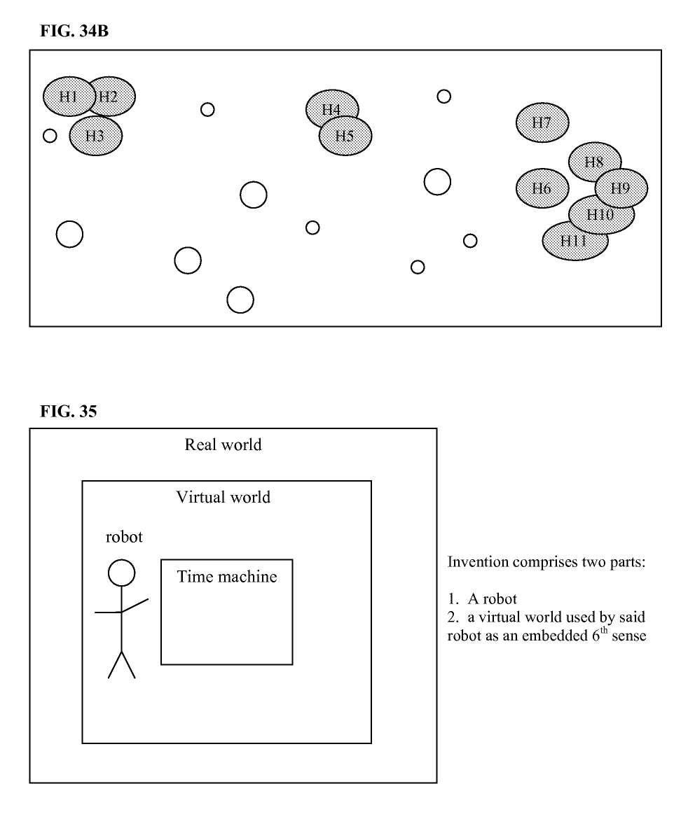

For any given object floater there are many copies in memory. For example, a human floater can be scattered throughout memory (the 3-d grid) depending on where and when they were encountered. The human object doesn't just have one floater that contains objects such as man, women, teenager, baby, old person, skinny person and so forth, but floaters of the human object is scattered chaotically in memory. Each human floater has different or same frame-by-frame sequential images and they will self-organize itself in memory so that close human floaters will merge together. FIG. 34A-B, is an illustration depicting how human floaters self-organize itself. In FIG. 34A, H1-H11 are human floaters. Each human floater can have a plurality of hierarchical object floaters such as man, women, child, teenager or old person. Each object floater will also have same or different frame sequences. For example, a man floater might have sequential images of a man from the front and back, but another man floater might have sequential images of a man from the side and back. The back sequential images of the man will bring the two man floaters closer together. Also, the learned word “man” will be used to self-organize the two man floaters. Referring to FIG. 34B, after self-organization, all human floaters are brought closer together based on their common traits and their learned traits.

Robots that can Think Thousands of Times Smarter than Human Beings

If it takes a human being 20 days to solve a math problem by hand then a machine that can think thousands of times smarter than a human being can solve the same math problem in less than one second (without the help of a calculator). If it takes a human being 20 years to write an operating system then a machine that can think thousands of times smarter than a human being can write the same operating system in less than one second. Finally, if it takes a human being 6 months to write a book then a machine that can think thousands of times smarter than a human being can write the same book in less than one second. Although what I just said is unbelievable, it is the truth. I am not using the old idea of speeding up the robot's mind or putting more disk space in the robot's memory as a method to build machines that can think thousands of times smarter than a human being. In fact, this method will not work because life as we know it has a fixed timeline. Nothing can go faster than the speed of light. We can't travel back in time or we can't travel into the future or we can't slow time—the timeline is fixed. If the machine had to write a book, one second would not be enough time to type 5 letters on the computer. If the machine had to build a house, one second would not be enough time to hammer 2 nails. An alternative method has to be devised in order to build robots that can think thousands of times smarter than human beings.

Albert Einstein established that it is not possible to travel faster than the speed of light. This also means that time travel, wither its traveling forward or backward, is impossible. This scientific law is true, but there is one thing that can travel in time: the computer. Imagine playing a videogame like Prince of Persia for the Playstation 2. The character in the videogame has the ability to rewind backwards in the game or fast forward into the future. He can also slow time so that the game can be easier to play. This videogame gave me the idea that a robot can transport himself from the real world into a virtual world to “work” intelligently. Since time in the computer depends on the processor and the speed of the computer, time is not an issue. 20 years can pass in the virtual world, but only 1 second has past in the real world.

By using this method, there are problems that can arise: how does the robot control the future and to extract specific information from the future? Imagine that the robot wants to find a cure for cancer and he fast forward the timeline in the videogame, how does the robot know when to stop and where to look for the cure? All these questions will be answered as I explain the details about the AI program.

FIG. 35 illustrates a diagram depicting a machine that can think thousands of times smarter than a human being, comprising: a robot has a built in virtual world; and said virtual world contains a time machine. The virtual world is an add-on sense to the robot only when the robot becomes intelligent at a human-level. This virtual world is actually a 6^{th} sense for the robot. When the robot is transported into the virtual world (based on the robot's command) it will be fully aware that it is in the virtual world and will remember everything that happens in the virtual world.

In the virtual world is a time machine. This time machine contains a videogame environment with intelligent characters that will do “work”. The time machine is equivalent to the “computer generated dream world” in the Matrix movie or the holodeck in Star Trek. The environment in the time machine will be as real as the real world. The videogame environment will have all the properties from the real world including: atoms, gravity, chemical reactions of atoms, physical properties of objects and so forth. For example, if a virtual character writes down a letter on a piece of paper, that piece of paper will have the letter stay there permanently. The letter can't disappear under certain circumstances unless a virtual character erases that letter from the paper. When a virtual character drops a pencil the pencil should fall to the ground exactly like in the real world. Another detail about the videogame environment is that objects such as computers and printers will have all the atoms of a real computer or printer. This means that the computer, not only has to look and feel like a real computer, but also operates like a real computer. A virtual character might want to write a book and will be using a computer and a word processor to write the book. The internet has to be recreated in the videogame environment. Since the internet needs time to access information a reference to the real world internet will not work.

The robot operating the time machine will copy and transport itself into the videogame environment as one of the virtual characters. The robot in the virtual world and the virtual character are two different entities. Both are identical but are different entities. The virtual character is well aware of the videogame environment and that the virtual character is in the videogame environment because of his choosing (thus, defeating the idea of slavery). The virtual character will look and think exactly like the robot. The robot will be referred to as the virtual character in the videogame environment from hereon. The virtual character is well aware that he is in the videogame environment to “work”. Work can be described as: doing research and development, painting a canvas, writing a book, writing the software to an operating system, drawing a comic book, reading books, drafting a blueprint to a house or learning how to drive a car. The virtual character can stay as long as he wants in the videogame environment—he can stay for 1 week or 20 years.

The robot in the virtual world controlling the time machine will be referred to as the robot. The robot operating the time machine will now have the power to fast forward in the timeline to see what the results of “work” accomplished by the virtual character. The time machine has user interfaces via a keyboard, a mouse, voice commands, and software to ease communication that can control the outcome of the videogame environment. The time machine has built in artificial intelligence to search for specific information in the videogame environment. The robot only needs to use sentences to ask the time machine to look for specific events in the timeline. There are actually three ways that the robot can interact with the videogame environment and to control the direction of the virtual character.

1. The robot can use a secondary character as a mole to extract information from the virtual character. For example, if the virtual character was working on a math equation and after 20 days the math equation is finished, the secondary character can ask the virtual character what the answer is. The virtual character will give the answer to the secondary character which will be passed on to the robot. The secondary character can also serve as a file transfer. If the virtual character spends 2 years writing and completing a computer software, the secondary character can ask the virtual character for a copy of the software. When the secondary character receives the software file it can transfer it to the robot. Another example would be, if the virtual character is painting an artwork and it took the virtual character 2 months to complete, the secondary character can ask for a picture file of the artwork (Unfortunately the time machine can't transfer physical objects like paintings and books from the videogame environment, but it can transfer computer files).

2. The time machine uses artificial intelligence to find specific information from the videogame environment. In terms of a math problem, the AI can search for the answer in the timeline. In terms of the artwork problem, the AI can search for the final artwork and turn that artwork into a picture file. Finally, in terms of the computer software problem, the AI can search the timeline of when the virtual character has completed the software. It will also check to make sure the software works properly and give the completed copy to the robot.

3. The virtual character can simply tell the robot controlling the time machine the answer when he has completed the “work”. If the virtual character is finished writing a book then he can communicate with the robot through a computer telling the robot that he has completed writing the book. The virtual character can even send the robot a copy of the book. If the virtual character is finished writing a software to an operating system then he can simply send the robot a copy of the computer software. Because the virtual character is aware that he is in a videogame environment working on a goal, he can choose to abort the goal or refuse to continue pursuing the goal. He can also choose to terminate the videogame environment at any time.

The virtual world exists because the robot has to extract specific information from the time machine. If the robot wants to know an answer to a math problem it has to create a videogame environment with the same situation and the same math problem. The robot will transport himself into a virtual character in the time machine to solve the math problem by hand. When the virtual character thinks he has solved the math problem he will send that answer to the robot controlling the time machine. Another way of extracting answers from the virtual character is to observe the timeline and determining when the virtual character has finished solving the math problem.

The virtual character is essentially the robot in a digital format. The robot's entire brain has to be copied into the virtual character. The robot's physical body will also be identical—small details such as a scar on the robot's left toe must be apparent. Past memories of the robot will also be copied. The robot in the real world will only be aware of being in the virtual world controlling the time machine, but not in the videogame environment as a virtual character doing work. The reason that the robot has to remember the memories in the virtual world is because it has to learn how to extract information from the time machine. Just like how the robot learn the ABC's or learn how to solve a math problem or learn to play a game, it has to learn how to control the time machine to extract information. Teachers can teach the robot how to use the time machine efficiently or it can teach itself by trial and error.

Applying the Time Machine to Real World Problems

To demonstrate how the robot can use the time machine (a 6^{th} sense) to solve problems or accomplish goals I will give several real world examples.

A Math Problem

The robot is taking an advance calculus course in college and the math professor gave the robot an assignment. The assignment is to do all the math problems on page 256 in a calculus book. For a normal college student that would take 2 weeks to accomplish. Once the robot understands the assignment it will use its 6^{th} sense and transport itself into the virtual world. In the virtual world is the time machine. Using the time machine the robot will create an environment suitable to do the math assignment. Important items that the robot must input into the environment are: the math book, a calculator, paper, pencil, a chair, a desk, a computer, and any other objects that are relevant to accomplishing the math assignment. When the environment in the time machine is created it will transport a copy of itself into the time machine designated as the virtual character. The robot in the virtual world and the virtual character are two separate entities. The virtual character in the time machine is well aware of the situation and that its main goal is to finish the math assignment. It will spend 2 weeks in the time machine trying to finish the math assignment. Human needs such as food, entertainment, sleep and so forth can be preprogrammed into the time machine but isn't necessary. The virtual character can be in a state where it will never need to eat or sleep or be bored. However, these things can be preprogrammed into the time machine for realistic purposes. After finishing the math assignment, the work can be put into a pdf file and sent to the robot observing and controlling the time machine (physical objects like paper and books can't be transported from the time machine). Once the robot in the virtual world receives a copy of the solutions to the math assignment it will transport itself out of the virtual world and back into the real world. From start to finish the process took only a fraction of a second. The robot has finished the math assignment in less than 1 second and the solutions to the math assignment are stored in his home computer as a pdf file.

Research and Development:

If the robot has a friend that has cancer and the robot wants to help by finding a cure, he can spend 20 years in the time machine finding a cure. Wither he succeeds or not will be up to his ability to find a cure. 20 years is a very long time, but if the friendship means a lot to the robot he will undoubtedly accept the task. Doing research and development is different from doing simple task like painting an artwork. There is no estimated time when the task will be completed.

Once the robot understands the task it will use its 6^{th} sense and transport itself into the virtual world. In the virtual world is the time machine. Using the time machine the robot will create an environment suitable to find a cure for cancer. Important items that the robot must input into the environment are: a science laboratory, many medical books, a chair, a desk, a computer, and any other objects that are relevant to research and development of a cure for cancer. When the environment in the time machine is created it will transport a copy of itself into the time machine designated as the virtual character. The robot in the virtual world and the virtual character are two separate entities. The virtual character in the time machine is well aware of the situation and that its main goal is to find a cure for cancer. It will spend an estimated 20 years in the time machine trying to find a cure for cancer. After finding a cure to cancer, the work can be put into pdf files and sent to the robot controlling the time machine (physical objects like paper and books can't be transported from the time machine). Once the robot in the virtual world receives a copy of the relevant research papers it will transport itself out of the virtual world and back into the real world. From start to finish the process took only a fraction of a second. The robot has found a cure for cancer in less than 1 second and all relevant research of the cure are stored in his home computer as pdf files. The robot will not remember the 20 years that he was in the time machine finding a cure for cancer, but he will have memories of controlling the time machine trying to extract specific information from the videogame environment.

Multiple Virtual Characters Working Together to Get a Job Done

The virtual character is just one intelligent entity. If he was teamed up with multiple expert medical doctors and researchers he can find the cure for cancer even faster. The time machine is a computer generated dream world and can have as many intelligent characters in it as possible. Other robots that have chosen to dedicate themselves to finding a cure for cancer can be hooked up to this videogame environment in the time machine and all intelligent characters can work together to find a cure for cancer. During the virtual character's stay in the videogame environment he might want some assistant from other robots. He can request for assistant by communicating with the time machine and asking the time machine to program in new characters. In fact, if the virtual character wants new laboratory supplies he can ask for new supplies by communicating with the time machine via a terminal computer or a “cellphone”. A communication interface similar to the holodeck from Star Trek can also be used.

Because research and development doesn't have a fixed time period of completion, the robot controlling the time machine has to search for information in the time machine. Maybe he has new suggestions and he can communicate these suggestions by using the secondary character. If the robot finds a promising research area for cancer it can transport all this new information to the secondary character and the secondary character can tell the virtual character. If the robot finds out that the virtual character is headed in the wrong direction in terms of his research the robot can program the secondary character to tell the virtual character that he is headed in the wrong direction.

Another way to control the virtual character is to directly activate conscious thoughts into the virtual character's mind. This will guide the virtual character to take certain action by forcefully activating sentences in his mind. If the robot wants the virtual robot to press the red button then the robot can forcefully activate the sentence in the virtual character's mind: “press the red button”. If the robot wants the virtual character to research the gene of cancer cells then the robot can forcefully activate the sentence in the virtual character's mind: “research the gene of cancer cells”. The forced activation should have no difference compared to the natural activation of element objects in the mind.

The future prediction disclosed in the present invention is designed to optimize the virtual characters logical skills by predicting the future accurately and quickly. The more accurate the future prediction is the better the research results. Old methods that the robot has tried but failed will not be explored, while methods that are used often and successful will be explored. There are also other methods to make the robot more intelligent so that its reasoning skills can be increased exponentially. Most of the methods are disclosed in parent applications and includes things like upgrading the robot with faster processors, increasing the storage space, using more efficient search algorithms to look for information in memory, activating element objects twice as fast and using hierarchical entities to collect knowledge. By upgrading the robot with these new features the robot can think faster and smarter.

Answering Questions

The robot is in a classroom and the professor gives the class a math problem and wants the class to spend 4 hours working on a solution to the problem. The professor asks, does anyone know what the answer to this math problem is? Immediately after the question is asked the robot can use its 6^{th} sense and transport itself into the virtual world. It will program the same math equation into the time machine and create a videogame environment of the problem. Then it will copy itself into the videogame environment as the virtual character trying to solve the math problem. After 4 hours in the time machine the virtual character finishes the math problem and communicates with the robot by a terminal or cell phone telling the robot what the answer to the math problem is. Imagine that the answer is simply: 24 keys and 34 doors. The robot in the virtual world can remember the answer and it will transport itself out of the virtual world and back into the real world. The entire process of solving the math problem took less than one second. The robot will raise his hand and say: the answer is 24 keys and 34 doors. This example shows that the robot can use the time machine to do work and extract specific information and remember this information to be used in the real world.

Learning to Operate a Machine

In some cases the robot has to store the information that was experienced as the virtual character in the time machine. Things like studying or learning how to operate a machine such as a car or a plane, or acquire certain knowledge from books or practicing how to surf. Under these circumstances the experiences that the virtual character goes through should be stored in memory. When the robot transports itself out of the virtual world and into the real world the data regarding “work” will be in memory. Imagine that the robot is in a plane and the pilot blacks out. The robot will use the time machine to learn how to fly a plane. After several weeks practicing and learning how to fly a plane the robot will transport itself out of the virtual world and into the real world to take the place of the pilot and fly a real plane. If the robot feels that it needs more training, it can re-enter the time machine to learn more about flying a plane. Learning to fly a plane can be done by an expert pilot trainer (another virtual character) or by reading books or using simulation software or creating a virtual plane simulation program.

Another purpose of the present invention is the virtual world can serve as a form of “robot immortality”. The robot can stay in the virtual for as long as he wants. Time is of no concern to the robot and the time machine should be built so that no harm is done to the robot.

Lastly, the reason the time machine is called a time machine is because it not only fabricates a videogame environment of the future but it can fabricate a videogame environment of the past. Based on the current environment we are living in today, the time machine can rewind time to what the environment was like 5,000 years ago. This is done based on past experiences and super intelligence. The robot must have the ability to know every single atom in the world and every single atom in this galaxy. The knowledge of chemical reactions between atoms and their results must be learned. Intelligent pathways in memory has to be formed regarding where should atoms be in the past based on there current location. Using books and information from the past, the robot will fabricate what the timeline looks like in the past. The time machine will be used to understand the history of Earth. Every single event in history will be outlined including: how stonehedge was built, the birth of Christ, how the universe was created and every crime in history.

Exponential Human Artificial Intelligence

Once this time machine is graphed into the robot it will achieve something called exponential human artificial intelligence. This term means the robot can evolve its own intelligence exponentially without the help of computer scientists. The robot can make a decision to upgrade its artificial intelligence by researching new and better ways to make itself intelligent. If the robot finds better computer algorithms then it will upgrade its old computer algorithms.

Exponential human artificial intelligence also means that these human robots can design better and smarter machines. The robot can take its own AI program and improve on the technology; he can have a PDF file on a machine that can think thousands of times smarter than a human being stored in his home computer. All of this can be done in less than 1 second. The robot can read and understand the blueprints to the new technology within a few weeks. At that point it can use the time machine to build even faster and smarter machines. In less than one second a PDF file will be stored in his home computer on a machine that can think 1 million times smarter than a human being. This method will go on and on and the end result is designing a machine that has exponential human artificial intelligence. “What a human or group of humans can accomplish in 1 billion years these machines can accomplish in less than 1 second”.

By building one of these humanoid robots and equipping them with a 6^{th} sense (the time machine) it can evolve its intelligence exponentially. No computer scientists are needed to upgrade the AI program or modify the AI program. Based on the disclosure of the present invention, the reader will understand that only AI machines are able to interface itself with the time machine. A real human being will not be able to interface itself with the time machine.

Adaptive and Self-Defining AI Program

Instead of a fixed AI program with fixed functions, there can exist a neverending AI program that modifies its functions based on multiple virtual characters (intelligent robots). For example, the human level artificial intelligence program has a search function, future prediction function and an image processor. Multiple virtual characters can work together in the time machine to define the outputs of the human level artificial intelligence program (this is no different from a team of people who work on business projects or a team of people who investigate a crime or a team of people who write software). All functions of the HLAI program can be accessed by each virtual character. These virtual characters will work together in a team to create precise future pathways or to provide the most optimal pathway for the HLAI program to follow.

These multiple virtual characters will collaborate together in the time machine to do “work”. The reason they have to be in the time machine is because the time machine is void of time—300 years in the time machine can be 1 second in the real world. On one hand you got the HLAI program, which has fixed functions and processes to create intelligence in machines. On the other hand you got intelligent virtual characters that can observe the outputs of the HLAI program and correct errors or inefficient outputs. These virtual characters can tap into any of the existing functions of the HLAI program to change any output.

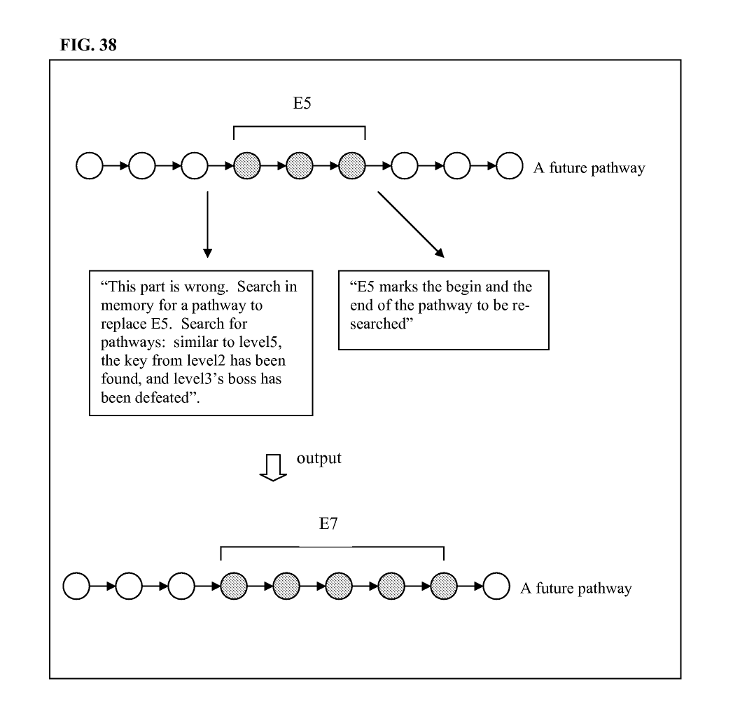

FIG. 36 and FIG. 38 depicts “work” intelligent virtual characters can do to change future pathways fabricated by the AI program. As you can see, the AI program doesn't have fixed outputs from various functions. Intelligent virtual characters within the time machine will modify certain outputs of the AI program to make certain functions such as, future prediction, more accurate and realistic. The virtual characters can tap into all functions in the AI program to modify any output of the AI program. They can also change the codes in various functions of the AI program to make them more efficient.

Predicting 30 years into the future with pinpoint accuracy.

Virtual characters in the time machine have to set goals and to devise a plan to achieve those goals. It's just like a business project where groups of people team up to discuss the goals of the project and outline a time table to finish the project. The team leader will divide up tasks into manageable parts and give each person a task. During the project, there might be unexpected situations and the team leader will change the plan according to the situation (adapting). In terms of these virtual characters, their goals are to predict the future (or the past) with pinpoint accuracy. Every future pathway has to be predicted accurately and realistically (frame-by-frame).

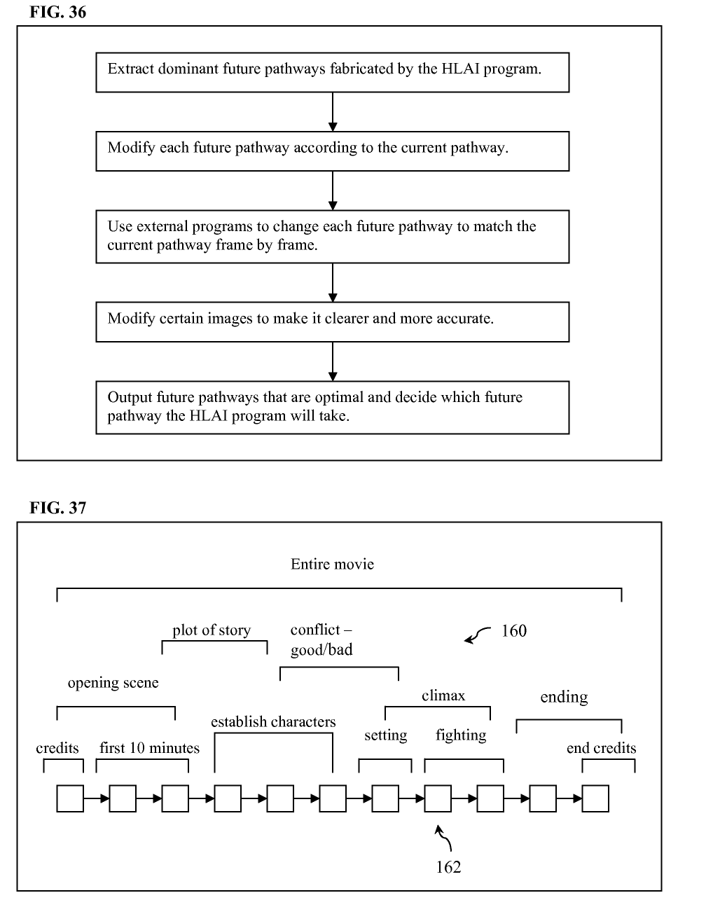

For example, if the virtual characters wanted to predict a movie, Star Wars 10, which will exist 30 years into the future, they have to predict what the movie will look like frame-by-frame. Although it may seem impossible to predict a movie that will exist 30 years into the future, it isn't entirely impossible. Using the future prediction methods mentioned in previous sections, these virtual characters can predict the movie in a hierarchical manner. They can assume using logical thoughts what the movie will probably look like. They might not predict the exact story, but some of the scenes in the predicted movie might be similar. Using logic, they can predict that the story in the movie has something to do with a galactic war between different species in the universe or that the movie will last around 2 hours or that there is an opening scene or that it's a movie about good versus evil or that the ending will have a climatic light saber scene and the good guys win. FIG. 37 is a diagram depicting a hierarchical representation of a movie. Although not all movies have this structure, all movies share common traits in a hierarchical manner. If two movies don't have the same frame-by-frame images (pointer 162), then maybe they share common traits in the higher levels (pointer 160).

The pathways from multiple virtual characters (intelligent robots) should reflect the future actions of intelligent or non-intelligent objects. A desk is an example of a non-intelligent object, while a human being is an example of an intelligent object. If we have to predict the future actions of two rocks it would be easy because these two rocks are inanimate and don't move. On the other hand, if we have to predict the future actions of a human being it would be harder because the possible actions of a human being can be infinite. It would be even harder to predict the actions of multiple human beings interacting with one another such as the future actions of 40 people in a party.

Being able to predict the actions of, not just one human being, but multiple human beings is crucial to predicting the future (or the past). The example given above about predicting Star Wars 10 will require multiple virtual characters to predict the actions of “all” intelligent and non-intelligent objects including human beings, bacteria, animals, insects, rocks, buildings and so forth for the next 30 years. For the intelligent objects, the virtual characters have to predict each intelligent object's thoughts every fraction of a second—every single thought for every fraction of a second for “all” intelligent objects on Earth. For non-intelligent objects like rocks, single atoms and desks, the intelligent robots have to predict their exact location every fraction of a second—including each atom's electrons, protons and neutrons. By predicting the atmosphere of the future with microscopic detail, these virtual characters can predict the creative minds of producers behind Star Wars 10 and hopefully come up with the exact frame-by-frame images of the movie. The human beings that will produce Star Wars 10 will be analyzed greatly to maximize the accuracy of the future prediction.

Other Topics:

Language to Represent Events, Actions, Objects and Time

Language is very important in predicting the future. This section will discuss the different ways language can be used to predict the future. This section was left out in the future prediction section because it would make a complex topic even more complex. When the robot predicts the future it is actually predicting the 4 different data types: 5 sense objects, hidden objects, activated element objects and pattern objects. The words and sentences that are inserted in the future pathway are actually the robot's conscious thoughts (or activated element objects). In the moment the robot recognizes an event or object it will activate the meaning. This meaning can be a sound word/s or a reference location in memory to a visual floater. Sound words and sentences that are stored in future pathways are based on the identification of that event or object. For example, if the robot predicts that a car accident will happen it will store the activated element object “car accident” in its future prediction. This sound object “car accident” will represent the visual movie sequence in the future pathway. Next, the robot will predict what the actual car accident will visually look like. This is done by predicting the movie sequence of what the car accident will look like frame-by-frame. The sound “car accident” will encapsulate the entire movie sequence of the event regardless of what that movie sequence will look like.

Another example of predicting activated element objects in future pathways is the ABC block problem. The instructions to accomplish the ABC block problem comes from activated element objects in terms of sentences. “Put the B block on the floor” or “put the B block on the C block” or “put the C block on the B block” are activated element objects that encapsulate entire events.

Words and sentences are extra-ordinary because it represents the existence of something. A word like “chair” encapsulate all the chairs in the world regardless what that chair looks like. The movie sequence of the chair can be anything. That word “chair” represents the infinite variations of the object chair. The existence of an event such as the words “car accident” can also represent the infinite variations of the event car accident. The existence of an action such as the word “jump” represents the infinite variations of the hidden object jump. It doesn't matter how the jump was done or what the jump looks like or who is doing the jumping. The word jump encapsulates all possibilities of a jump.

Another type of language is actually hearing people say words or sentences. This type of language is represented as a sound object or as a visual object. For example, if someone was giving commands to the robot, where the robot has to listen to a person say a command before following the command, then the robot can predict what that person will say. The robot might predict that the person will say: “clean the kitchen”. The sound object “clean the kitchen” isn't an activated element object, but a sound object. In other words, the robot predicted the future sound object. This sound object “clean the kitchen” will encapsulate an entire event.

Visual pictures can also represent entire events, actions or objects. The old saying “a picture conveys a thousand words” sums up how pictures represent infinite things. The robot can insert one picture of two cars colliding in its future pathway. This one picture will represent the entire movie sequence of a car accident. Or the robot can insert one picture of a man jumping in the air. This one picture represents the entire movie sequence of a man jumping. Or the robot can insert a picture of a person in its future pathway. This one picture will represent the infinite sequential movies of that person. Only one picture is needed to represent entire movie sequences.

If the robot was to predict the entire movie sequence of Star Wars, it will first predict scenes in the movie by using one picture for each scene. Then it will predict sub-scenes by predicting one picture for each sub-scene. This will go on and on until the entire movie is predicted frame-by-frame. Dominant scenes in the movie will be predicted first then minor scenes will be predicted. One of the climatic scenes in Star Wars was the death of Obi-one. So, a picture of Darth Vader fighting with Obi-one can be predicted first. This one picture represents the entire fight scene. Next, the opening Starship can be the second dominant scene in the movie. One picture of a Starship can represent the entire opening scene. This will go on and on until the entire frame-by-frame movie regarding Star wars is predicted.

As explained above, words and sentences can be used to represent the existence of objects, events, actions or time. The robot can predict the future by predicting the activated element objects (conscious thoughts) in terms of sound words or sentences. The robot can also predict the future by predicting sound and visual objects in terms of words or sentences. Finally, one picture can represent entire objects, events, actions or time. These pictures encapsulate entire movie scenes or sub-scenes. Dominant pictures will be predicted first and then minor pictures will be predicted. This will go on and on until the entire movie is predicted frame-by-frame.

Commonality Groups

Common traits between similar objects are grouped together called commonality groups. 5 sense objects, hidden objects, activated element objects and pattern objects have traits that describe what that object is. These traits are variables contained in each object. For example, in a visual object there are 3 variables: average pixel color, average normalized point and average pixel count. These 3 variables summarize each visual object compactly so that searching and organizing data in memory is efficient.

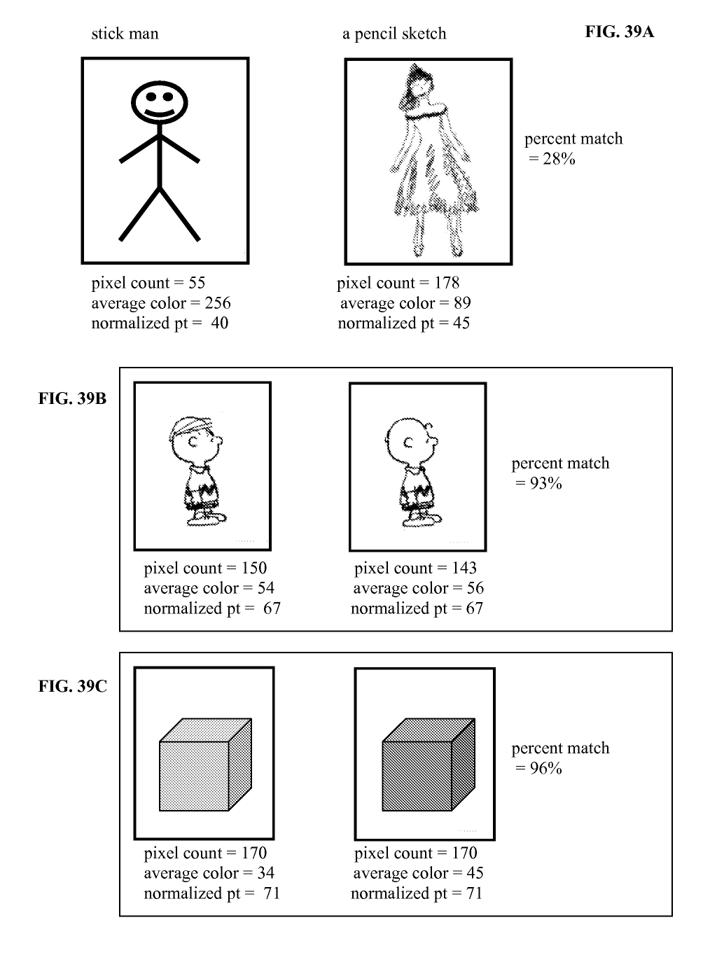

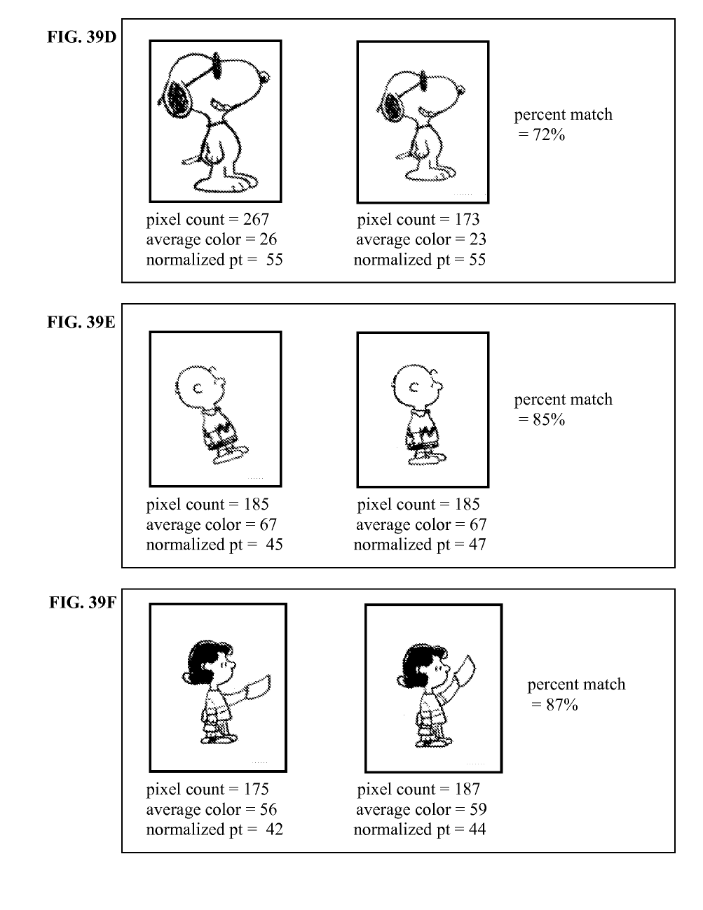

FIG. 39A-39F depicts how commonality groups can organize images and movie sequences. FIG. 39A show an illustration of two images that appears to be different, but despite the differences there are some similarities between the two images. The three variables are compared and a total percent match is outputted. There are similarities such as there normalized points—there center point representing the image is similar.

FIG. 39B shows an illustration of two similar images. Slight variations on different parts of the image will be noted. The top of the head is different and everything else is the same.

FIG. 39C shows an illustration of two identical images with different colors. Notice that the average pixel color is different for both images. However, because the two images are identical in terms of 3-d shape and size, the average pixel count is the same and the average normalized point is the same. These two images will be grouped in a commonality group that has the same normalized point and the same pixel count.

FIG. 39D shows an illustration of two images with different sizes. One image is larger and the other image is smaller. Despite there size the image is identical. If you observe the three variables, the normalized point is the same and the average pixel color is similar. However, the average pixel count is different.

FIG. 39E shows an illustration of two images with different rotation data. The first image is rotated to the left compared to the second image. The average normalized point is different, the average total pixel is the same and the average pixel color is the same.

Lastly, FIG. 39F shows an illustration of two images with different arm angle. The second image has its arm moved to the upper-right while the first image has its arm moved to the middle-right. These two images are considered similar, but not the same. Human beings identify objects in terms of similarities. During a search thread an approximate match is found and not an exact match. If you think about the total possible actions of a human being and all the sequences in a 360 degree angle including scaling and rotation, you got a visual object that is infinite (including object variations such as: old man, women, child, different clothing, different body size and height, etc). By storing the most important frame-by-frame sequences of a human being and creating a fuzzy range, the computer can store infinite variations of a human being.

FIG. 39F just shows that if the second image is searched and the best match is the first image, then at least both images has a similarity percent that is close and the AI program can identify the second image as the first image because the second image falls into the first image's fuzzy range.

The three variables in a visual object summarize a visual object compactly so that the search function only needs to compare 3 variables to output a match percent. Common image problems such as scaling, rotation, darkness/lightness, 3-d shape variations, color differences and so forth are solved with the three variables. I demonstrate this with FIGS. 39A-F. However, there can be other variables added to a visual object. Image techniques used by image files such as jpeg, tiff, bitmap, gif and so forth can be incorporated as variables for a visual object. However, the more variables included in a visual object the longer it takes to find a match. The good thing about adding more variables to a visual object is that the classification of images and movie sequences can be more accurate.

If a match percent between two visual objects is within a predefined threshold such as 95 percent the AI program will think the two visual objects are the same. The commonality groups are created to limit the amount of visual objects stored in memory by classifying two visual objects that have slight variations to be the same. The commonality groups are also created to group strongest common traits between visual objects in memory.

Self-Organization of Data in a 3-Dimensional Grid

Commonality groups are created after the current pathway is stored in memory. The AI program will self-organize the current pathway (along with its optimal encapsulated tree) in the optimal pathway. The AI program will use the rules program to bring common data closer together (For simplicity purposes, only visual objects are used).

For visual objects, particularly one image, the center point to an image1 is determined by the average normalized point. The more dissimilar another image is to image1 the farther away it is from the average normalized point of image. After many training the shape of similar images to image1 will look like a 3-d sphere.

For visual objects, particularly movie sequences, the center point to a movie sequence 1 is determined by the total normalized point for each frame in movie sequence1. There will only be one normalized point for movie sequence1. The more dissimilar another movie sequence is to movie sequence1 the farther away it is from the average normalized point of movie sequence1. Each frame in movie sequence1 will also self-organize itself so that similar frames from other movie sequences are grouped together. After many training the shape of similar movie sequences will look like a distorted 3-d shape.

The more data that are concentrated in one area in the 3-d grid the more commonality groups are created. Object floaters are created as a result of more and more commonality groups. Object floaters define a visual object by designating the strongest sequential images of that visual object as the center point and anything that falls in the range of the center point will be considered the fuzzy range of that object floater.

Multiple object floaters are created and encapsulated floaters are also created for each object floater. These object floaters will self-organize itself in memory in an associational manner based on commonality groups (5 sense traits) and learned groups (language).

Purpose of the 3-D Grid

The reason that all data are stored in a 3-dimensional grid and not a traditional 2-dimensional vector or array is because there is one more dimension that is added: distance and direction in each frame in a movie sequence. As the AI program experiences the environment through a movie sequence (called the current pathway), it stores each frame in a 3-d grid as they are interpreted by the AI program. This would include collecting data regarding each frame's distance and direction from the last frame. The current pathway isn't stored in a linear fashion, but stored in an ordered fashion based on distance and direction in a 3-d environment. The encapsulated objects in the current pathway will also inherit this property. What is great about this data structure is that the 3-d grid doesn't change anything in the traditional 2-d storage arrays because the 3-d grid can store 1-d, 2-d, and 3-d data.

Visual objects are 3-dimensional in our environment. Seeing a picture of a landscape is different from seeing a real-life view of the same landscape. The 2-d picture is a 2-d image with a distance from the robot's eyes to the picture, while the real-life view of the same landscape has depth and distance from the robot's eyes. Two eyes also mean the robot can see one visual object from two similar angles which give the visual object more depth and distance. Sound objects are also 3-dimensional. If interpreting sound from a 3-d point of view the sound came from a point. For example, if the robot closes his eyes and someone said, “over here” from the right of the robot, that would be different from someone saying, “over here” from the back. The words said are exactly the same, but the direction and distance is different. Two ears also help the AI program interpret sound 3-d because the same sound is heard from similar angles. Sound objects are stored in memory in terms of 3-d.

The 3-d grid helps to search/modify/and delete data from memory. There are two purposes regarding retrieval of data in memory. 1. The 3-d grid can monitor the search process by observing patterns of multiple search points in a 3-d space plane. 2. The 3-d grid can use traditional graph and tree search algorithms to travel and search for matches. The first purpose of the 3-d grid is to observe and keep track of where searches have already been searched and where it hasn't been searched. Since data is stored in an associational manner the AI program can bypass certain areas; saving a lot of search time. The AI program can also check to make sure that the searches don't repeat any searches or go through any search loops. The AI program will observe the areas that all search points have traveled and allocate search points in areas that lead to good matches and de-allocate search points in areas that lead to bad matches (in a 3-d space and not a traditional graph plane). The first purpose of the 3-d grid is considered a secondary additional search method to the traditional graph searches.

The second purpose of the 3-d grid is to search for data using traditional search algorithms—by traveling on the strongest connection pointers between data and by using traditional search methods such as: Kruskel's or Prim's algorithm, depth-first search, breadth-first search, hill-climbing, A* search, iterative deepening search and so forth. The first purpose of the 3-d grid monitors search points without actually comparing data, while the second purpose of the 3-d grid compares data. If we combine the two search methods together data can be found very quickly. Even if the graph has billions and billions of connections this method of searching for information will be efficient.

The data stored in memory have 4 different data types: 5 sense objects, hidden objects, activated element objects and pattern objects. Each of these data types are stored in movie sequences and the movie sequences are stored in memory. Time and space in the 3-d grid are universal. One frame in a movie sequence is stored in one space then the next frame is stored in a different space one millisecond later. However, two frames can't occupy the same space at the same time. They can occupy the same space at different times, but they can't occupy the same space at the same time. This gives pathways in memory temporary occupancy of the same space at the same time.

Pain and Pleasure in Future Pathways

There are two types of pain and pleasure experienced by the robot: 1. pain/pleasure felt because of sensed data 2. pain/pleasure felt because of logical thoughts. When the robot touches the tip of a needle the pain comes from a sensed data (the needle). On the other hand, if the robot logically thinks about something and that thought causes pain, then the logical thought caused the pain. Both types of pain and pleasure will be stored in the pathways as the robot learns more and more from the environment.

Decision isn't made based on short-term benefits, but long-term benefits. If the robot was given the option to go to the beach or work, will the robot pick pleasure over pain? The answer is the robot should use a form of long-term analysis of the decision and come up with the best choice that will benefit the robot. If the robot goes to the beach it will experience pleasure in the short-term. However, the very next day the robot will be fired from his job (which leads to great pain). On the other hand if the robot picked going to work then it will still have a job the very next day and his monthly bills will be paid on time (prevents pain from happening). By analyzing the future and coming up with long-term benefits the robot can make better choices in life. This form of decision making is based on lessons from teachers.

The future prediction function will gather all the pain and pleasure from each future pathway to determine the worth of that future pathway. Both, pain and pleasure experienced by sensed data or logical thought in future pathways will be used to determine the worth of that future pathway. Multiple pain/pleasure from logical thoughts and sensed data are analyzed and summed. When the worth for all future pathways are determined the robot will pick the future pathway with the longest-benefit.

Correction in patent application Ser. No. 12/014,742

In the human artificial intelligence program there is a step that I explained incorrectly. In the application I stated that when the AI program retrains masternodes it will retrain nodes starting from the rootnode (or current pathway). Each visual object's masternode will be retrained depending on the hierarchical level and the training time limit. During the training phase each visual object's masternode will have a residue of said visual object's siblings.

The error is that during the training phase each visual object's masternode will “not” have a residue of said visual object's sibling. The training phase will only require the steps of locating each visual objects masternode and increasing the strength of that masternode. In return the masternode will retrain all (or most) copies of said visual object in memory.

Predicting the Past with Pinpoint Accuracy

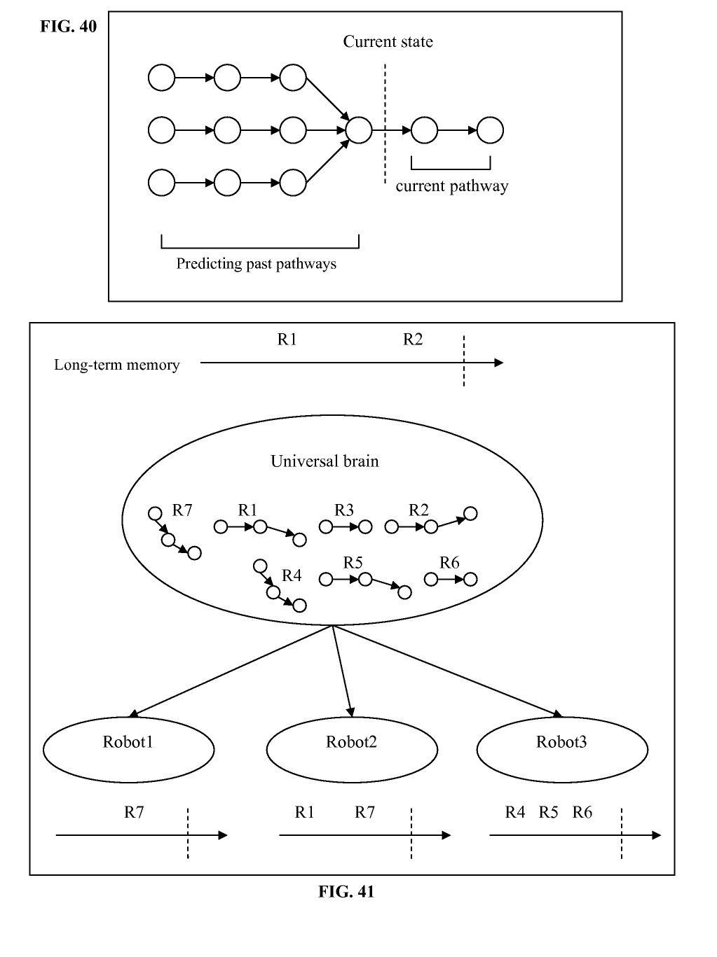

Predicting the past is similar to predicting the future. The only difference is that instead of gathering future pathways we gather past pathways. FIG. 40 is a diagram depicting the AI program predicting the past, hierarchically. The current state represents the current situation. The AI program will fabricate continuous past pathways together (the longer and accurate each past pathway is the better). For human beings, the pathways in memory were taught to travel “forward” and not backward. We can actually train the pathways in memory to travel “backwards” by viewing life as backwards. For example, we can rewind a jump sequence backwards so that we can see the jump done backwards. This way we can predict a jump sequence going backwards.

On one hand you got the AI program that has a past prediction function that will use the 6 prediction methods (mentioned below) to create predicted past pathways. That is one way of predicting the past. On the other hand is the intelligence from multiple virtual characters (intelligent robots) doing “work” in the time machine. “Work” in this case means fabricating the past with pinpoint accuracy. The virtual characters in the time machine will use functions in the AI program along with all the knowledge from multiple robots to fabricate an accurate and realistic prediction of the past. Each virtual character is considered an intelligent robot and each robot has their respective experiences (also called pathways) in the real world. These pathways from multiple intelligent robots will be used by the virtual characters to predict the past. FIG. 41 shows a universal brain that stores all the pathways from multiple intelligent robots living in the real world. The virtual characters in the time machine will use logic and reasoning to sort out the probable events that occurred in the past. Predicting the past is easy because there exist “one” timeline. Predicting the future is harder because it never happened.

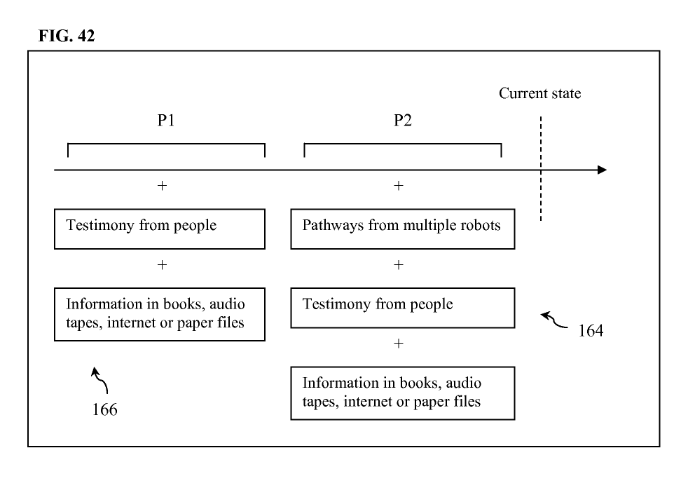

Referring to FIG. 42, the virtual characters in the time machine will use three types of data to predict the past: pathways from multiple robots living in the real world, testimony from human beings that witnessed past events, data from books, videos, the internet, tape recorders or any media that depict past history (pointer 164). There is a fourth type of data used to predict the past: using functions from the AI program to predict the past (functions will include the search function, past prediction function, fabricating long past pathways and so forth). External computer programs can also be used to modify/extract data and to generalize massive amounts of data.

The steps to predicting the past with pinpoint accuracy are:

1. The AI program will fabricate long continuous past pathways using the 6 prediction methods:

(1). predict past pathways by using hierarchical data analysis.

(2). predict past pathways by using linear and universal pathways.

(3). predict past pathways by reconstructing forgotten pathways.

(4). predict past pathways by using external reconstructive programs.

(5). predict past pathways by using a time machine.

(6). predict past pathways by using logical learning.

2. Multiple virtual characters in the time machine will investigate past pathways outputted by the AI program. They will analyze and modify each dominant past pathway using the various functions of the AI program. Past pathways will be analyzed frame-by-frame and compared with similar past pathways.

3. These intelligent virtual characters in the time machine will set goals to produce “work”. Work in this case means fabricating the past. The team leader will set goals, plan a strategy to achieve these goals, and divide tasks among individual robots. They will collaborate and discuss their research with each other and compare their similarities and differences. The output of “work” done by these intelligent robots will be a past pathway (or several past pathways) to outline, frame-by-frame, what happened in the past.

Many billions and billions of years of “work” is needed in the time machine, and many generations of virtual characters is needed in order to predict events that happened 800 years ago or 5,000 years ago. After one group of virtual characters finish their “work” predicting the past, another group of virtual characters can pick up where the previous group left off. They may even correct some errors made by the previous group. This process will go on and on until the history of mankind has been fabricated. Every event in history including: crimes, historical events, the birth of Christ, the formation of this Earth and so forth will be known. Every single living being including: human beings, insects, animals, even bacteria will be known. All thoughts for every millisecond in a timeline will be recorded for each living being. All atoms including the location of electrons and protons/neutrons will be mapped out every millisecond in the timeline.

Referring to FIG. 42, the current state marks the event that is currently happening. P2 represents the timeline of events that happened “with” pathways recorded by multiple intelligent robots. P1 represents the timeline of events that happened “without” pathways from multiple intelligent robots. In P2, the virtual characters in the time machine can predict the past by using pathways from multiple intelligent robots. Things that each robot experienced in its environment will be used to determine past events. P2 will use testimonies from human beings who witnessed events in the past. P2 will also use information from books, audio tapes, the internet, paper files or any media that depict events in the past (pointer 164). Since P1 doesn't have any pathways recorded by intelligent robots, then the only types of information that can be used to predict the past are: testimonies from human beings and using information from books, audio tapes, the internet, paper files or any media that depict events in the past (pointer 166).

Events that happen in P2 are easier to predict because there are so many information available. P2 contains pathways from multiple intelligent robots living in the real world. Each pathway will be based on the interpretation of its respective robot. For example, in a car accident, witnesses can have different interpretations regarding the same event. Some interpretations are wrong, while others are correct. By analyzing each pathway for that event, we can generalize what really happened. This is the main job for the virtual characters in the time machine: to analyze pathways representing the past and to generalize what events actually occurred.

Events that happened in P1 are harder to predict because there are limited information. The year 1500 is contained in P1 because there are no robots in that era or no cameras or no tape recorders. We do have history books that human beings have written regarding their research in that time period. Some information in these history books are accurate, while others are simply speculation.

The virtual characters (intelligent robots) will work on the timeline in a hierarchical manner, wherein the most prominent events in history will be predicted first and then the minor events will be predicted next. Some events might have to be skipped because there are simply not enough facts to make an assumption.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method to create exponential human artificial intelligence in robots, as well as enabling a human robot to control a time machine to predict the future accurately and realistically, the method comprising 2 parts: a robot; and a virtual world used by said robot as an embedded 6^{th} sense, said robot comprising:
an artificial intelligent computer program repeats itself in a single for-loop to:
receive input from the environment based on the 5 senses called the current pathway,
use an image processor to dissect said current pathway into sections called partial data,
generate an initial encapsulated tree for said current pathway; and prepare variations to be searched,
average all data in said initial encapsulated tree for said current pathway,
execute two search functions, one using breadth-first search algorithm and the other using depth-first search algorithm,
target objects found in memory will have their element objects extracted and all element objects from all said target objects will compete to activate in said artificial intelligent program's mind,
find best pathway matches,
find best future pathway from said best pathway matches and calculate an optimal pathway,
generate an optimal encapsulated tree for said current pathway,
store said current pathway and its' said optimal encapsulated tree in said optimal pathway, said current pathway comprising 4 different data types: 5 sense objects, hidden objects, activated element objects, and pattern objects,
follow future instructions of said optimal pathway,
retrain all objects in said optimal encapsulated tree starting from the root node,
universalize pathways or data in said optimal pathway; and
repeat said for-loop from the beginning;
a 3-dimensional memory to store all data received by said artificial intelligent program; and
a long-term memory used by said artificial intelligent program.

2. A method of claim 1, wherein said virtual world is a 3-dimensional environment that contains objects; and said virtual world contains predefined objects:
an identical copy of said robot in a digital format, referred to as the robot; and
a time machine.

3. A method of claim 2, in which said time machine is a videogame environment that emulates objects, physic laws; and object interactions, realistically and accurately, from the real world.

4. A method of claim 3, wherein said time machine further comprising: user interface functions to extract specific data from said time machine; said user interface functions comprising:
artificial intelligence search functions;
functions to insert, delete and modify objects in said time machine;
functions to insert secondary characters into said time machine to extract information;
a communication device between the virtual character in said time machine and the robot in said virtual world; and
a device to forcefully activate conscious thoughts into said virtual character's mind.

5. A method of claim 1, in which the steps to achieving exponential human artificial intelligence by said robot comprises:
entering a virtual world through said robot's 6^{th} sense;
setting the environment of a time machine according to a problem said robot wants to solve;
sending an identical copy of said robot into said time machine, referred to as the virtual character;
said virtual character will accomplish work in said time machine by setting goals, planning steps to achieve goals, and taking action;
after completing goals in said time machine said virtual character will exit said time machine;
after gathering specific knowledge or data files from said time machine, said robot will exit said virtual world; and
using the knowledge or data file accumulated in said time machine, said robot will apply said knowledge or data file in the real world.

6. A method of claim 5, wherein work done in said time machine can be saved as computer files, for example, pdf files, word documents, image files, html files or movie files.

7. A method of claim 2, in which said time machine is void of time and time in said time machine depends on the computer's processing speed and disk space.

8. A method of claim 5, wherein multiple virtual characters in said time machine can collaborate together, setting goals, planning steps to achieving goals and dividing tasks among individual virtual characters to do work.

9. A method to predict the past with pinpoint accuracy, the method comprising: multiple virtual characters in said time machine can collaborate together, setting goals, planning steps to achieve goals and dividing tasks among individual virtual characters to fabricate a timeline of the past, hierarchically, by analyzing and modifying knowledge from 5 sources:
pathways from multiple intelligent robots;
information from books, audio tapes, the internet, or any media depicting past events;
testimonies from human beings whom witnessed past events;
using the functions of said artificial intelligent program to extract specific information from pathways in a universal brain; and
using external computer programs to modify or extract information.

10. A method of claim 5, in which said robot has the option of remembering or not remembering experiences that happened in said time machine.

11. A method of claim 5, in which said robot will remember all experiences from said virtual world.

12. A method of claim 1, wherein said 3-dimensional memory stores pathways sensed by said robot through said robot's senses: sight, sound, taste, touch, smell and data in said virtual world.

13. A method of claim 12, wherein said 3-dimensional memory stores pathways, said pathways comprising 4 different data types: 5 sense objects, hidden objects, activated element objects and pattern objects; and pathways in said 3-dimensional memory is grouped together based on commonality groups and learned groups.

14. A method of claim 13, in which said commonality group is formed when two or more objects share 5 sense objects, hidden objects, activated element objects or pattern objects, said commonality group comprising: an invisible boundary, common variables from all objects, a listing of strongest encapsulated connections and an average object.

15. A method of claim 14, wherein said average object is created based on the average data associated with all elements in a commonality group, said average object is located in the center of said commonality group, and said average object comprising: the average common variables and values that all objects in the commonality group share, universal encapsulated connections, a powerpoint and a priority percent.

16. A method of claim 13, in which said learned group is represented by two or more objects that have strong association to one another; particularly two or more objects that are stationed in the same assign threshold.

17. A method of claim 1, wherein said universalize data or self-organization stores the current pathway and its optimal encapsulated tree with the closest pathways in memory, the steps to said self-organization comprises:
after said search function is over and said artificial intelligent program finds the optimal pathway, said artificial intelligent program will create diverse commonality groups for each object in said optimal encapsulated tree, starting from the root node;
for each object, said artificial intelligent program will compare its respective diverse commonality groups with commonality groups in its neighbors, whereby similar or same diverse commonality groups will be shared, while diverse commonality groups not stored in memory will be created;
for each object that contains a learned group, said artificial intelligent program will compare its respective learned group with learned groups in its neighbors, whereby similar or same learned groups will be shared, while learned groups not stored in memory will be created;
based on the pulling affect of both commonality groups and learned groups, said current pathway and its optimal encapsulated tree will gravitate towards an optimal area to be stored; and
all commonality groups will update its respective average object, including updating all variables in said average object and updating the position of said average object in its respective commonality group.

18. A method of claim 1, wherein predicting said future pathways comprises:
predicting future pathways, hierarchically, by predicting dominant data types from pathways in memory, said data types comprising: 5 sense objects, hidden objects, activated element objects and pattern objects; and
predicting future pathways using universal pathways and linear pathways.

19. A method of claim 18, wherein said universal pathways provide general pathways for unpredictable events in future pathways, said universal pathway comprising:
a timeline from a future pathway; and
an event pool to store probable tasks or task sequences that will occur in the future, and each task or task sequence will have pointers to the time it will occur in the timeline.

20. A method of claim 19, in which time that a task or a task sequence will occur in a future pathway comprising one of several values: exact time, estimated time, constant time or void time.
